(19) United States
(12) Patent Application Publication
(10) Pub. No.: US 2023/0309450 A1
(43) Pub. Date: Oct. 5, 2023

(54) COTTON HARVESTER CONTROL USING PREDICTIVE MAPS

(71) Applicant: Deere & Company, Moline, IL (US)

(72) Inventors: Jeffrey S. WIGDAHL, Ames, IA (US); Brandon C. CARLSON, Ankeny, IA (US); Nathan R. VANDIKE, Geneseo, IL (US)

(21) Appl. No.: 18/194,178

(22) Filed: Mar. 31, 2023

Related U.S. Application Data
(60) Provisional application No. 63/327,250, filed on Apr. 4, 2022.
(60) Provisional application No. 63/327,251, filed on Apr. 4, 2022.
(60) Provisional application No. 63/327,243, filed on Apr. 4, 2022.

(51) Int. Cl. A01D 46/08

(52) U.S. Cl. CPC A01D 46/085

(57) ABSTRACT

An information map is obtained by a cotton harvesting system. The information map maps values of a first characteristic to different geographic locations in a worksite. An in-situ sensor detects a value of a second characteristic as the cotton harvester operates at the worksite. A predictive map generator generates a predictive map that predicts values of the second characteristic at the different geographic locations in the worksite based on a relationship between the values of the first characteristic in the information map and values of the second characteristic detected by the in-situ sensor. The predictive map can be output and used in automated machine control.

### CROSS-REFERENCE TO RELATED APPLICATIONS

The present application is based on and claims the benefit of U.S. provisional Pat. applications Serial No. 63/327,250, filed Apr. 4, 2022, Serial No. 63/327,251, filed Apr. 4, 2022, and Serial No. 63/327,243, filed Apr. 4, 2022, the content of which are hereby incorporated by reference in their entirety.

### FIELD OF THE DESCRIPTION

The present descriptions relate to mobile machines, particularly mobile cotton harvesting machines.

### BACKGROUND

There are a wide variety of different mobile machines. Some such mobile machines include cotton harvesters. Some cotton harvesters have a set of row units on the front end of the harvester. The row units act to funnel cotton plants, planted in rows, into the individual row units. In the example of a cotton picker, each row unit has one or more rotatable drums to which a plurality of spindles are mounted. The spindles are rotated to pick seed cotton from the opened cotton bolls entering the row unit. The spindles extend radially from the drum and are supported for rotation about a longitudinal axis of the drum. Each of the spindles is elongate along a longitudinal axis. The spindles also rotate about their longitudinal axis. Rotation of the spindles separates the seed cotton from the cotton plant. Each row unit includes a rotatable doffer that rotates in a counter rotating manner, relative to the rotation of the spindles about the longitudinal axis of the drum, to remove the cotton material from the spindles. The cotton material is then transferred (such as using an air system or other conveying mechanism) into a containment area. On some cotton harvesters, the cotton is transferred from the containment area into a module forming area. Once a module (e.g., a cotton bale) is formed, a door opens at the rearward end of the cotton harvester so that the module can be ejected onto the field. In other examples, the cotton picker may not have a module forming area on-board.

In the example of a cotton stripper, each row unit has two rotatable stripper rolls to which a combination of one or more brushes and one or more bats are mounted. The stripper rolls, and thus the one or more brushes and one or more bats, are rotated to strip cotton as well as other material from the cotton plant entering the row unit. The material is then transferred using a cross auger to an air system. The air system conveys the material to a cleaning system where cotton is separate from the other stripped material. The separated cotton is then transferred, by the air system, to into a containment area. On some cotton harvesters, the cotton is transferred from the containment area into a module forming area. Once a module (e.g., a cotton bale) is formed, a door opens at the rearward end of the cotton harvester so that the module can be ejected onto the field. In other examples, the cotton stripper may not have a module forming area on-board.

The discussion above is merely provided for general background information and is not intended to be used as an aid in determining the scope of the claimed subject matter.

### SUMMARY

An information map is obtained by a cotton harvesting system. The information map maps values of a first characteristic to different geographic locations in a worksite. An in-situ sensor detects a value of a second characteristic as the cotton harvester operates at the worksite. A predictive map generator generates a predictive map that predicts values of the second characteristic at the different geographic locations in the worksite based on a relationship between the values of the first characteristic in the information map and values of the second characteristic detected by the in-situ sensor. The predictive map can be output and used in automated machine control.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view of one example of a cotton harvester as a cotton stripper.

FIG. 2 is a perspective view of one example of a cotton harvester as a cotton picker.

FIG. 3 is a partial pictorial, partial schematic illustration of one example cotton harvester.

FIG. 4 is a block diagram showing some portions of an agricultural cotton harvesting system, including, among other things, a cotton harvester in the previous FIGS., in more detail, according to some examples of the present disclosure.

FIG. 5 is a block diagram showing one example of a predictive model generator and predictive map generator.

FIG. 6 is a block diagram showing one example of a predictive model generator and predictive map generator.

FIGS. 7A-7B (collectively referred to herein as FIG. 7) show a flow diagram illustrating one example of operation of an agricultural cotton harvesting system in generating a map.

FIG. 8 shows a flow diagram illustrating one example of operation of an agricultural cotton harvesting system in determining likely plugging.

FIG. 9 is a block diagram showing one example of a cotton harvester in communication with a remote server environment.

FIGS. 10-12 show examples of mobile devices that can be used in an agricultural cotton harvesting system.

FIG. 13 is a block diagram showing one example of a computing environment that can be used in an agricultural cotton harvesting system.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

In one example, the present description relates to using in-situ data, such as in-situ feedrate data, taken concurrently with an operation, such as a cotton harvesting operation, in combination with prior or predicted data, such as prior or predicted data represented in a map, to generate a predictive model and a predictive map, such as a predictive feedrate model and a predictive feedrate map. The predictive feedrate model models a relationship between a characteristic, such as feedrate, or values thereof, represented in the in-situ data and one or more mapped characteristics or values thereof. In some examples, the predictive feedrate model can be used to generate a predictive feedrate map that predicts feedrate, or predictive values of feedrate, at different geographic locations in the field that the cotton harvester is harvesting at, such as unharvested locations, based on the feedrate model and the one or more mapped characteristics, or values thereof. In some examples, the predictive feedrate map can be used to control a cotton harvester during a cotton harvesting operation.

In one example, the present description relates to using in-situ data, such as in-situ yield data, taken concurrently with an operation, such as a cotton harvesting operation, in combination with prior or predicted data, such as prior or predicted data represented in a map, to generate a predictive model and a predictive map, such as a predictive yield model and a predictive yield map. The predictive yield model models a relationship between a characteristic, such as yield, or values thereof, represented in the in-situ data and one or more mapped characteristics or values thereof. In some examples, the predictive yield model can be used to generate a predictive yield map that predicts yield, or values of yield, at different geographic locations in the field that the cotton harvester is harvesting at, such as unharvested locations, based on the yield model and the one or more mapped characteristics, or values thereof. In some examples, the predictive yield map can be used to control a cotton harvester during a cotton harvesting operation.

In one example, the present description relates to determining a likelihood of plugging on the cotton harvester with a plug prediction system. The plug prediction system obtains a predictive map, such as the predictive feedrate map, and a feedrate threshold. Where a predictive value of feedrate for a location, as provided by the predictive feedrate map, exceeds a threshold feedrate value (such as by a threshold amount), the plug prediction system can determine that plugging will likely occur at the location and can provide a plug prediction output indicative of likely plugging at the location. The plug prediction output can be used to control the cotton harvester, such as to control the speed of the cotton harvester at that location, or can be used to generate an indication, such as an alert, recommendation, display, as well as various other indications, to an operator or user, or both.

A cotton stripper has a plurality of row units, each row unit including a stripper head. The stripper heads engage rows of cotton plants and rotating rolls (e.g., stripper rolls) on the stripper heads strips cotton bolls and other material from the cotton plants. The stripper rolls and one or more augers convey the gathered bolls and other material further into the cotton harvester, such as towards a crop conveyance system, such as an air system. The material flows through the air system further into the cotton stripper, such as towards a cleaning system, where the material is cleaned (e.g., cotton separated from other material) and then further onto an accumulator and module builder.

A cotton picker has a plurality of row units, each one including a picking unit that includes among other things, one or more drums, each drum including a plurality of spindles. The spindles are rotated to pick seed cotton from opened cotton bolls engaged by the row units. The picked cotton is conveyed from the row units further into the cotton harvester by a crop conveyance system, such as an air system towards an accumulator and module builder.

Besides their different row unit configurations, as well as other structural differences, cotton strippers and cotton pickers are generally differentiated by their mode of harvesting. Cotton strippers strip all of the cotton bolls (as well as other material) from the cotton plant, whereas cotton pickers pick seed cotton from “ripe” (opened) cotton bolls, generally leaving “unripened” (unopened) cotton bolls on the plant to be picked in a subsequent operation. There can be common elements among cotton strippers and cotton pickers, as will be described below.

In one example, the present descriptions relate to obtaining an information map such as a vegetative index map. A vegetative index map illustratively maps georeferenced vegetative index values (which may be indicative of vegetative growth or plant health) across different geographic locations in a field of interest. One example of a vegetative index includes a normalized difference vegetation index (NDVI). There are many other vegetative indices that are within the scope of the present disclosure. In some examples, a vegetative index map be derived from sensor readings of one or more bands of electromagnetic radiation reflected by the plants. Without limitations, these bands may be in the microwave, infrared, visible or ultraviolet portions of the electromagnetic spectrum. A vegetative index map can be used to identify the presence and location of vegetation. In some examples, these maps enable vegetation to be identified and georeferenced in the presence of bare soil, crop residue, or other plants, including crop or other weeds. The sensor readings can be taken at various times during the growing season (or otherwise prior to harvest), such as during satellite observation of the field of interest, a fly over operation (e.g., manned or unmanned aerial vehicles), sensor readings during a prior operation (e.g., prior to harvesting) at the field of interest, as well as during a human scouting operation.

In one example, the present description relates to obtaining an information map, such as a yield map. The yield map illustratively maps georeferenced values of yield across different geographic locations in a field of interest. In some examples, the yield map is a predictive yield map that maps georeferenced predictive yield values across different geographic locations in a field of interest. The predictive yield map may be derived from sensor readings during a prior operation at the field of interest, or during a fly-over (e.g., drone, satellite, etc.) of the field of interest. In some examples, the predictive yield map is derived from human scouting of the field of interest. In some examples, the predictive yield map is derived from a vegetative index (or a vegetative index map). In some examples, the predictive yield map can be derived from historical values of yield. In some examples, the predictive yield map can be derived from yield values provided by the seed provider, for instance, some seed providers can provide characteristic values for plants resulting from their seeds, such as yield values. In some examples, the yield map may be a historical yield map that maps historical yield values across different geographic locations in a field of interest. The historical yield map may be derived from sensors readings during a prior harvesting operation at the field of interest. In other examples, the historical yield map may be derived from operator or user input, such as post harvesting yield data provided by an operator or user. These are merely some examples. In other examples, the yield map may be derived in other ways.

In one example, the present description relates to obtaining an information map, such as a prior product application operation map. The prior product application operation map illustratively maps georeferenced product application values across different geographic locations in a field of interest. Product application values can include product application location values, indicative of locations where product was or was not applied, product application rate values, indicative of a rate at which product was applied, product amount values, indicative of an amount of product applied, product type values, indicative of the type of product applied, as well as various other product application values.. The prior product application operation map may be derived from sensor readings during a prior product application operation at the field of interest by a product application machine (such as spraying operation performed by a sprayer, a fertilizer application operation performed by a field fertilizer spreader (dry or liquid), a dry spreading operation performed by a dry spreader, etc.). For example, the machine(s) performing the prior operation(s)may include one or more sensors, that may provide sensor data indicative of the product application characteristics (e.g., locations, rates, amounts, type, etc.), or values thereof. In one example, the prior product application map may be derived from a prior planting/seeding operation at the field, and may include values that indicate the locations of planted seeds, the spacing of planted seeds, the spacing of seed rows, the population of planted seeds, as well as genotype(s) of the seeds planted. These are merely some examples. In other examples, the prior product application operation map may be derived in other ways.

In one example, the present description relates to obtaining an information map, such as a prior irrigation operation map. The prior irrigation operation map illustratively maps georeferenced irrigation values (e.g., application location, application rates, application amounts, etc.) across different geographic locations in a field of interest. The prior irrigation operation map may be derived from sensor readings during one or more prior irrigation operations at the field of interest. For example, the irrigation machine may include one or more sensors, such as one or more of flow rate sensors, pressure sensors, as well as various other sensors, that may provide sensor data indicative of water application, or values thereof. In some examples, the irrigation map may be derived form an irrigation prescription or plan that provides commanded irrigation parameters that were used to control a previous irrigation operation. These are merely some examples. In other examples, the prior irrigation operation map may be derived in other ways.

In one example, the present description relates to obtaining an information map, such as a soil moisture map. The soil moisture map illustratively maps soil moisture values across different geographic locations in a field of interest. The soil moisture map may be derived from sensor readings, such as from sensors deployed on machines that previously operated at the worksite, or on machines that conduct fly-over operations at the worksite (e.g., satellites, planes, drones, etc.). The soil moisture map may be derived from soil surveys, such as core sampling. The soil moisture map may be derived from soil moisture modeling, which may include, as inputs, a variety of data, such as weather data, crop residue data, as well as a variety of other data. In other examples, the soil moisture map may be derived from a soil moisture index. In some examples, the soil moisture map may be derived from data provided by third-party sources, such as government or research institutions that provide public soil moisture data. These are merely some examples. In other examples, the soil moisture map may be derived in other ways.

In one example, the present description relates to obtaining an information map, such as a soil type map. The soil type map illustratively maps soil type values across different geographic locations in a field of interest. Soil type can refer to taxonomic units in soil science, wherein each soil type includes defined sets of shared properties. Soil types can include, for example, sandy soil, clay soil, silt soil, peat soil, chalk soil, loam soil, and various other types of soil. The soil type map may be derived from sensor readings, such as from sensors deployed on machines that previously operated at the worksite, or on machines that conduct fly-over operations at the worksite (e.g., satellites, planes, drones, etc.). The soil type map may be derived from soil surveys, such as core sampling. In other examples, the soil type map may be derived in other ways.

In one example, the present description relates to obtaining an information map, such as a historical feedrate map. The historical feedrate map illustratively maps georeferenced feedrate values from operations at the field of interest (by the same machine or another machine). The historical feedrate map may be derived from sensor readings during one or more prior cotton harvesting operations at the field of interest. For example, the cotton harvesting machine may include one or more sensors, such as one or more of feedrate sensors, as well as various other sensors, that may provide sensor data indicative of feedrate, or values thereof. These are merely some examples. In other examples, the historical feedrate map may be derived in other ways.

In one example, the present description relates to obtaining an information map, such as an optical characteristic map. The optical characteristic map illustratively maps georeferenced electromagnetic radiation values across different geographic locations in a field of interest. Electromagnetic radiation values can be from across the electromagnetic spectrum. This disclosure uses electromagnetic radiation values from infrared, visible light and ultraviolet portions of the electromagnetic spectrum as examples only and other portions of the spectrum are also envisioned. An optical characteristic map may map datapoints by wavelength (e.g., a vegetative index). In other examples, an optical characteristic map identifies textures, patterns, color, shape, or other relations of data points. Textures, patterns, or other relations of data points can be indicative of presence or identification of an object in the field, such as crop state (e.g., downed/lodged or standing crop), plant presence, plant type, insect presence, insect type, etc. For example, plant type can be identified by a given leaf pattern or plant structure which can be used to identify the plant. For instance, a canopied vine weed growing amongst crop plants can be identified by a pattern. Or for example, an insect silhouette or a bite pattern in a leaf can be used to identify the insect. The optical characteristic map can be derived using satellite images, optical sensors on flying vehicles such as UAVS, or optical sensors on a ground-based system, such as another machine operating in the field before the cotton harvesting operation. In some examples, optical characteristic maps may map three-dimensional values as well such as crop height when a stereo camera or lidar system is used to generate the map. The optical characteristic map can be derived in other ways as well.

These are merely examples. Various other maps that map various other characteristics, and values thereof, are contemplated herein.

In one example, the present description relates to obtaining in-situ data from in-situ sensors taken concurrently with an operation. In one example, the in-situ sensors include feedrate sensors that generate in-situ data indicative of feedrate, or values thereof. The in-situ data can be georeferenced to different locations at the field.

In one example, the present description relates to obtaining in-situ data from in-situ sensors taken concurrently with an operation. In one example, the in-situ sensors include yield sensors that generate in-situ data indicative of yield, or values thereof. The in-situ data can be georeferenced to different locations at the field.

The present discussion proceeds, in some examples, with respect to systems that obtain one or more maps of a worksite (e.g., field), such as one or more of a vegetative index map, a yield map, a prior product application operation map, a prior irrigation operation map, a soil moisture map, a soil type map, a historical feedrate map, an optical characteristic map, and other maps, and also use an in-situ sensor, such as a feedrate sensor, to detect a variable indicative of a characteristic (or value thereof), such as feedrate (or a value thereof). The systems generate a model that models a relationship between the georeferenced values on the obtained map(s) and the corresponding georeferenced output values from the in-situ sensor. The model is used to generate a predictive map that predicts, for example, feedrate (or values thereof) at different geographic locations in the field that is being operated at, such as at unharvested areas. The predictive map, generated during an operation, can be presented to an operator or other user or used in automatically controlling a cotton harvester during a cotton harvesting operation, or both.

The present discussion proceeds, in some examples, with respect to systems that obtain one or more maps of a worksite (e.g., field), such as one or more of a vegetative index map, a yield map, a prior product application operation map, a prior irrigation operation map, a soil moisture map, a soil type map, a historical feedrate map, an optical characteristic map, and other maps, and also use an in-situ sensor, such as a yield sensor, to detect a variable indicative of a characteristic (or value thereof), such as yield (or a value thereof). The systems generate a model that models a relationship between the georeferenced values on the obtained map(s) and the corresponding georeferenced output values from the in-situ sensor. The model is used to generate a predictive map that predicts, for example, yield (or values thereof) at different geographic locations in the field that is being operated at, such as at unharvested areas. The predictive map, generated during an operation, can be presented to an operator or other user or used in automatically controlling a cotton harvester during a cotton harvesting operation, or both.

The present discussion also proceeds, in some examples with respect to a plug prediction system that obtains a predictive map, such as a predictive feedrate map, and a threshold value, such as a threshold feedrate value, and provides a plug prediction output, indicative of a likelihood of plugging, based thereon. For example, where the predictive feedrate value for a given location exceeds, such as by a threshold amount, from a threshold feedrate value, plug prediction system may determine that plugging will likely occur at that location and generates a plug prediction output indicative of the likely plugging. The plug prediction output can be used to generate a display, alert, recommendation, notification, or other indication to an operator or user, or both, on an interface mechanism or can be used in automatically controlling a cotton harvester during a cotton harvesting operation, or both.

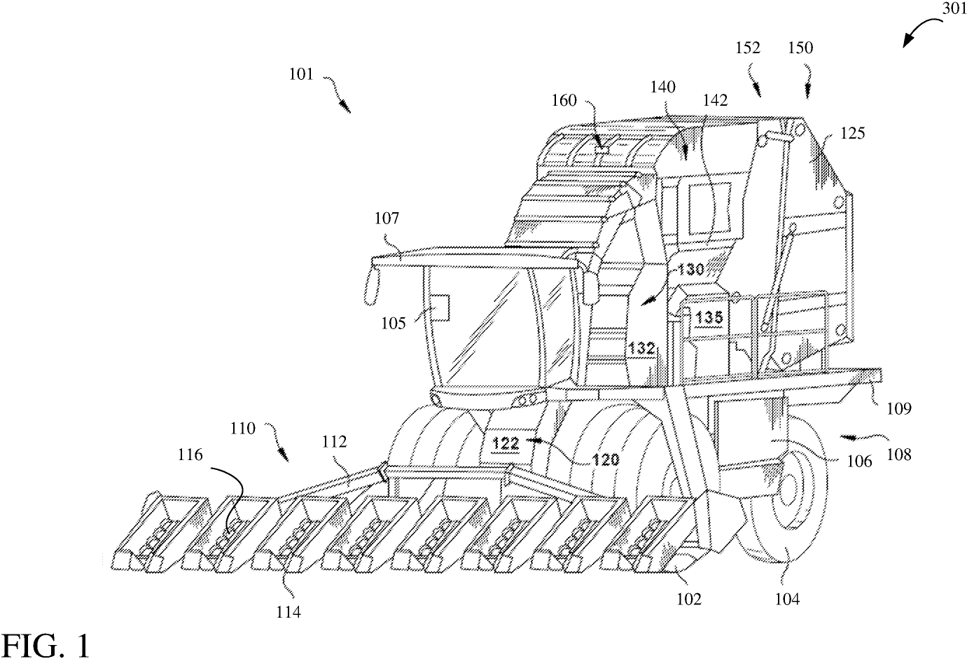

FIG. 1 is a perspective view showing one example of a cotton harvester 301 as a cotton stripper 101. Cotton stripper 101 includes a chassis 109 (e.g., main frame) that is supported by a set of ground engaging elements, illustratively shown as front wheels 102 and rear wheels 104, although, in other examples, other types of ground engaging elements are contemplated, such as tracks. An operator compartment 107 is supported by the chassis 109 and includes operator interface mechanisms 105. A power plant 108, such as an engine 106, can be supported below the chassis 109. Water, lubricant, and fuel tanks may also be supported on the chassis 109 though are not shown in FIG. 1.

A cotton stripper header 110 includes a frame 112 and is coupled to the chassis 109. As cotton stripper 101 moves throughs a field, cotton stripper header 110 engages rows of cotton plants. The cotton stripper header 110 includes a plurality of cotton stripper heads 114 (e.g., cotton stripper row units) arranges side-by-side across the front of cotton stripper 101. Each cotton stripper head 114 may be identical to other stripper heads 114, so the internal structure for one stripper head 114 will be described below with the understanding that the description may also apply to other stripper heads 114. The cotton stripper heads 114 engage rows of crop plants at the field and strip cotton bolls (ripe and unripe) as well as other plant matter from the cotton plants. The cotton stripper heads 114 each include a pair of opposed (e.g., disposed on opposite sides of the stripper head 114 and thus the opposite side of the respective row) stripper rolls 116 that are configured to rotate to strip material from the cotton plants. Each stripper roll 116 can include a combination of one or more bats and one or more brushes disposed about the circumference of each roll and extending along a length of the stripper roll 116. The stripper header 110 can also include a cross auger (not shown) that delivers material stripped by each stripper head 114 towards conveyance system 120 (illustratively shown as an air system).

The cotton stripper 101, as illustrated, includes as a conveyance system, an air system 120. Air system 120 can include a crop conveyor component that conveys cotton through the cotton harvester, one or more sensors 160, and a crop conveyor device (e.g., one or more air ducts and an air flow generator). In some examples, the crop conveyer component can include one or more air ducts 122. The air ducts 122 are coupled to, and aligned with header 110, so that the cotton harvested by the header 110 can be transported into the cotton stripper 101 through the air ducts 122 of the air system 120 powered by air flow (e.g., an air flow generated by an air flow generator, such as a fan or blower). In some examples, there is a respective air duct 122 for each stripper head 114.

The one or more sensors 160 can monitor air flow and/or crop mass flow in the air ducts 122 of the air system 120. In some implementations, one or more sensors 160 can be positioned in the air ducts 122. As an example, cotton stripper 101 may include a plurality of mass flow sensors 160 that are mounted across the width of the air ducts 122. In other examples, one or more sensors 160 can be positioned adjacent the air ducts 122. In the illustrated example, cotton stripper 101 may include a plurality of mass flow sensors 160 that are mounted behind the air ducts 122 with one cotton mass flow sensor 160 mounted per row unit. The air flow, and/or crop mass flow, can be monitored using various types of sensors such as, but not limited to, an HDOC yield monitor, a vacuum sensor, an air speed sensor, etc. As an example, the HDOC yield monitor is a microwave-based controller that bounces a signal off a flowing crop to detect a change in velocity with a slowing (or non-existent) crop flow indicative of an air duct 122 being overloaded or plugged. The mass flow information generated by mass flow sensors 160 can be used to derive feedrate or yield.

As illustrated in FIG. 1, cotton stripper 101 can also include a cleaner system 130. Material is travels from the air ducts 122 to the cleaner system 130 and then from the cleaner system 130 to an accumulator system 140. In some examples, the ducts 122 can include a bypass system such that seed cotton, already separated from foreign material can bypass the cleaner system 130 and travel to the accumulator system 140. The foreign material, and cotton interspersed with foreign material, being heavier, will naturally fall to the cleaner system 130. The cleaner system 130 can include a crop cleaner component that cleans the harvested cotton, that is, separates the seed cotton from other material. In some examples, the crop cleaner component can include a cleaner 132 which may include a plurality of components, such as a feeder, doffers, brushes, saw drums, grid bars, a trash auger, ducts, an air generator (e.g., a fan or a blower), as well as various other components. In addition, cotton harvester cotton harvester 301 may include load sensors that sense a hydraulic pressure used to drive components of the cleaner system 130 at given speeds. Where the components of the cleaner system 130 are driven by an electric motor, the load sensors may be one or more speed sensors and current sensors.

The cleaned cotton is transported from the cleaner system 130 to the accumulation system 140.

The accumulation system 140 can include a crop accumulator component that temporarily stores the harvested crop and one or more sensors. In some examples, the crop accumulator component can comprise an accumulator 142 and an accumulator capacity monitor. The accumulator 142 is configured to receive cotton harvested by the cotton stripper header 110.

Cotton stripper 101 also includes a feeder system 135 that receives cotton from the accumulator 142. The feeder 135 can include a plurality of rollers and motors that compress and transfer the cotton to a cotton receptacle 152 at a feedrate.

The cotton receptacle 152 can include a module builder 150 having one or more bailer belts. The module builder 150 can build a module of cotton, such as cotton bale. In other examples, the cotton stripper 101 need not include a module builder, instead, the cotton may be ejected by the air system 120 into an internal hopper, and/or ejected from the harvester into an accompanying holding tank (which may be towed by another vehicle).

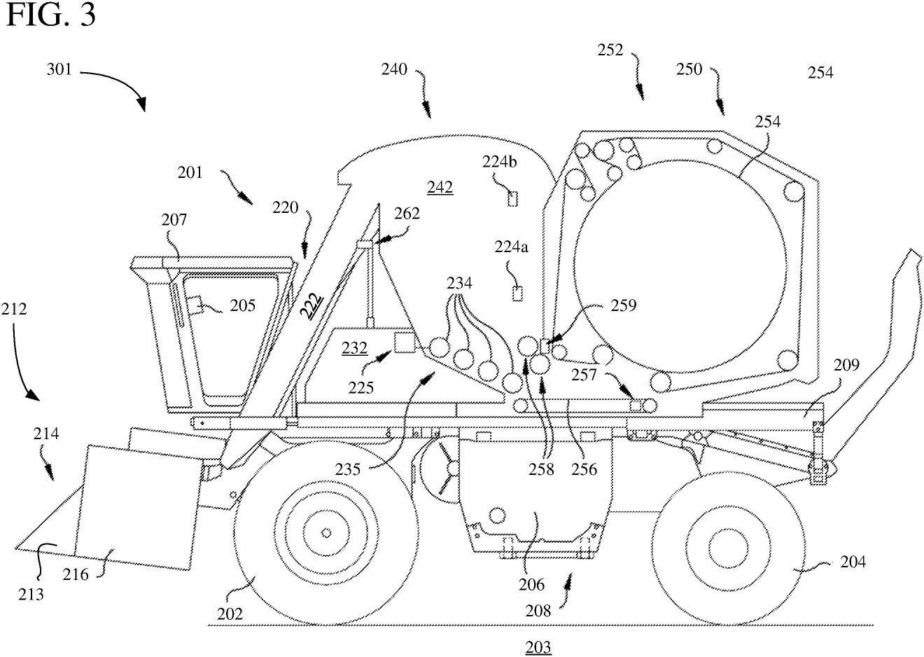

The internal structure and operation of accumulator system 140, feeder system 135, and crop receptacle 152 of cotton stripper can be similar to accumulator system 240, feeder system 235, and crop receptacle 252 of cotton picker 201 which is shown in more detail in FIG. 3. It will be understood that the cotton stripper 101 can include various components illustrated and detailed in FIG. 3.

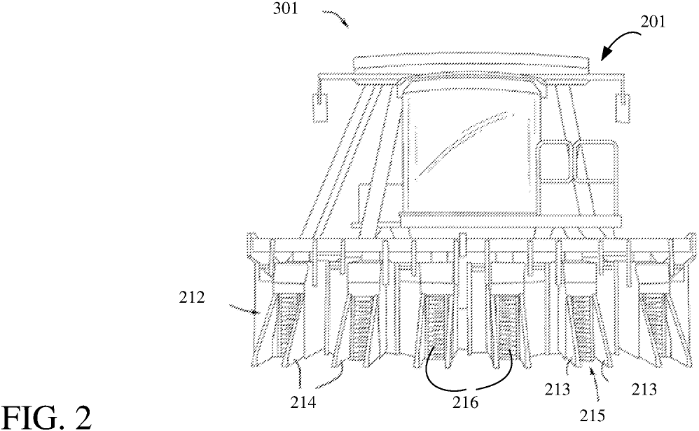

With reference now to FIGS. 2 and 3, which illustrate an example of a cotton harvester 301 as a cotton picker 201. Cotton picker 201 includes a chassis 209 (e.g., main frame) that is supported by a set of ground engaging elements, illustratively shown as front wheels 202 and rear wheels 204, although, in other examples, other types of ground engaging elements are contemplated, such as tracks. An operator compartment 207 is supported by the chassis 209 and includes operator interface mechanisms 205. A power plant, such as an engine 206, can be supported below the chassis 209. Water, lubricant, and fuel tanks 232 may also be supported on the chassis 209.

A cotton picker header 212 is coupled to the chassis 209. As cotton picker 201 moves through a field 203, cotton picker header 212 engages cotton plants. The cotton picker header 212 includes a plurality of cotton picker heads 214 (e.g., cotton picker row units) arranged side-by-side across the front of the cotton picker 201. Each cotton picker head 214 may be identical to the other picker heads 214, so the internal structure for one picker head 214 will be described below with the understanding that the description may also apply to other picker heads 214. Each picker head 214 may include a pair of separators 213 laterally spaced apart from one another and forming a channel 215 disposed between them. The channels 215 receive the rows of cotton plants as the cotton picker 201 is driven through field 203, and, as such, the channels 215 are laterally spaced apart from one another substantially the same distance as the rows of the cotton plants to be picked. Each cotton picker head 214 includes a respective cotton picking unit 216. Cotton picking units 216 remove cotton from the cotton plants.

The cotton picker 201, as illustrated, includes as a conveyance system, an air system 220. Air system 220 can include a crop conveyor component that conveys cotton through the cotton picker 201, one or more sensors 262, and a crop conveyer device (e.g., one or more air ducts and an air flow generator). In some examples, the crop conveyor component can include one or more air ducts 222. The air ducts 222 are coupled to, and aligned with header 212 so that the cotton harvested by the header 212 can be transported into the cotton picker 201 through the air ducts 222 of the air system 220 powered by air flow (e.g., an air flow generated by an air flow generator, such as a fan or blower). In some examples, there is a respective air duct 222 for each picker head 214.

The one or more sensors 262 can monitor air flow and/or crop mass flow in the air ducts 222 of the air system 220. In some implementations, one or more sensors 262 can be positioned in the air ducts 222. As an example, cotton picker 201 may include a plurality of mass flow sensors 262 that are mounted across the width of the air ducts 222. In other examples, one or more sensors 262 can be positioned adjacent the air ducts 222. In the illustrated example, cotton picker 201 may include a plurality of mass flow sensors 262 that are mounted behind the air ducts 222 with one cotton mass flow sensor 262 mounted per row unit. The air flow, and/or crop mass flow, can be monitored using various types of sensors such as, but not limited to, an HDOC yield monitor, a vacuum sensor, an air speed sensor, etc. As an example, the HDOC yield monitor is a microwave-based controller that bounces a signal off a flowing crop to detect a change in velocity with a slowing (or non-existent) crop flow indicative of an air duct 222 being overloaded or plugged. The mass flow information generated by mass flow sensors 262 can be indicative of feedrate or yield.

In some examples, a crop receptacle 252 is coupled to the air duct system 220. In some examples, the crop receptacle 252 is a module builder 250 having one or more baler belts 254. As an example, module builder 250 can be used to build a module of the crop, such as a bale of cotton. In other examples, the crop may be ejected by the air duct system 220 into an internal hopper, and/or ejected from the harvester into an accompanying holding tank (which may be towed by another vehicle).

The cotton harvester 301 can includes an accumulator system 240. The accumulator system 240 can include a crop accumulator component that temporarily stores the harvested crop and one or more sensors 224. In some examples, the crop accumulator component can comprise an accumulator 242 and an accumulator capacity monitor. The accumulator 242 is configured to receive cotton harvested by the cotton picker header 212.

Sensors 224, or feedback devices, can be coupled to the accumulator 242 to monitor an accumulator fill level and provide an accumulator fill level signal indicative of the fill level in the accumulator 242. In some examples, the accumulator 242 has a low-level sensor 224a and a high-level sensor 224b. When the high-level sensor 224b detects accumulated crop at the high level, a signal can be provided to control the accumulator 242 to empty its crop contents. That is, for example, when the high-level sensor 224b detects the accumulator fill level is at or exceeds (e.g., rises above) the pre-set sensor threshold level, a control signal can be generated to empty the accumulator 242. In some examples, the high-level sensor 224b can be configured, such as by its position in the accumulator 242, to be triggered before the accumulator 242 is completely full. Triggering of the low-level sensor 224a indicates that the accumulator 242 has released a sufficient amount of crop and a control signal can be generated to control the accumulator 242 to stop emptying its crop contents. That is, for example, when the low-level sensor 224a detects the accumulator fill level is at or exceeds (e.g., drops below) a pre-set sensor threshold level, the accumulator 242 can be controlled to stop emptying. The low-level sensor 224a can be configured, such as by its position in the accumulator 242, to prevent emptying of the crop from the accumulator 242 below a desired low level. In one example, sensors 224 are infrared sensors.

In some examples, the accumulator system 240 can include other sensors to determine an accumulator fill rate and/or fill level. In some examples, multiple sensors can be mounted at an inlet to the accumulator 242 to monitor mass flow rate (e.g., flow rate of the crop through the inlet, or other portions of the conveyor system) and accumulator fill rate. These sensors can measure the mass flow rate and to measure the time to fill the accumulator 242 between the low-level and high-level sensors 224a, 224b (e.g., accumulator fill rate) to determine yield or feedrate.

In some examples, it is beneficial to determine the mass in the accumulator 242 when the fill level is between the low-level and high-level sensors 224a, 224b. In such examples, sensors can monitor the mass flow entering and exiting the accumulator 242 (e.g., which can be based on past accumulator cycles) and incorporate this data with additional timing data. As an example, a cotton bale diameter can be used to determine a bale growth rate, and the bale growth rate can be used to determine the amount of mass from the size of the module diameter thereby creating a better estimation of mass in accumulator 242. This information can be used to derive yield or feedrate.

A feeder 235 is coupled to the chassis 209. The feeder 235 can receive cotton from the accumulator 242. The feeder 235 can include a plurality of meter rollers 234 that compress the cotton and transfer the cotton to the module builder 250 at a feed rate. A first motor 225 is positioned to rotate the plurality of meter rollers 234. The first motor 225 may be hydraulic or electric.

A plurality of beater rollers 258 cooperate with the plurality of meter rollers 234 to transfer the cotton to the module builder 250 at the feed rate. A second motor 259 can be positioned to rotate the plurality of beater rollers 258. The second motor 259 may be hydraulic or electric.

A feeder belt 256 can receive crop from the plurality of meter rollers 234 and beater rollers 258 and transfer the crop to the module builder 250 at the feed rate. A third motor 257 is positioned to rotate the feeder belt 256. The third motor 257 may be hydraulic or electric.

Cotton harvester 301 may also include a plurality of load sensors. With a load sensor for each of the first motor 225, second motor 259, and third motor 257. Where the motors are hydraulic, the load sensors may be pressure sensors that detect a hydraulic pressure used to drive the motors at given speeds. Where the motors are electric, the load sensors may be one or more speed sensors and current sensors. This information can be used to derive feedrate or yield. This information can be used to derive feedrate or yield.

In addition, cotton harvester 301 may include load sensors that sense a hydraulic pressure used to drive components of the header (e.g., cross auger, stripper rolls, drums, etc.). Where the components of the header are driven by an electric motor, the load sensors may be one or more speed sensors and current sensors. This information can be used to derive feedrate or yield.

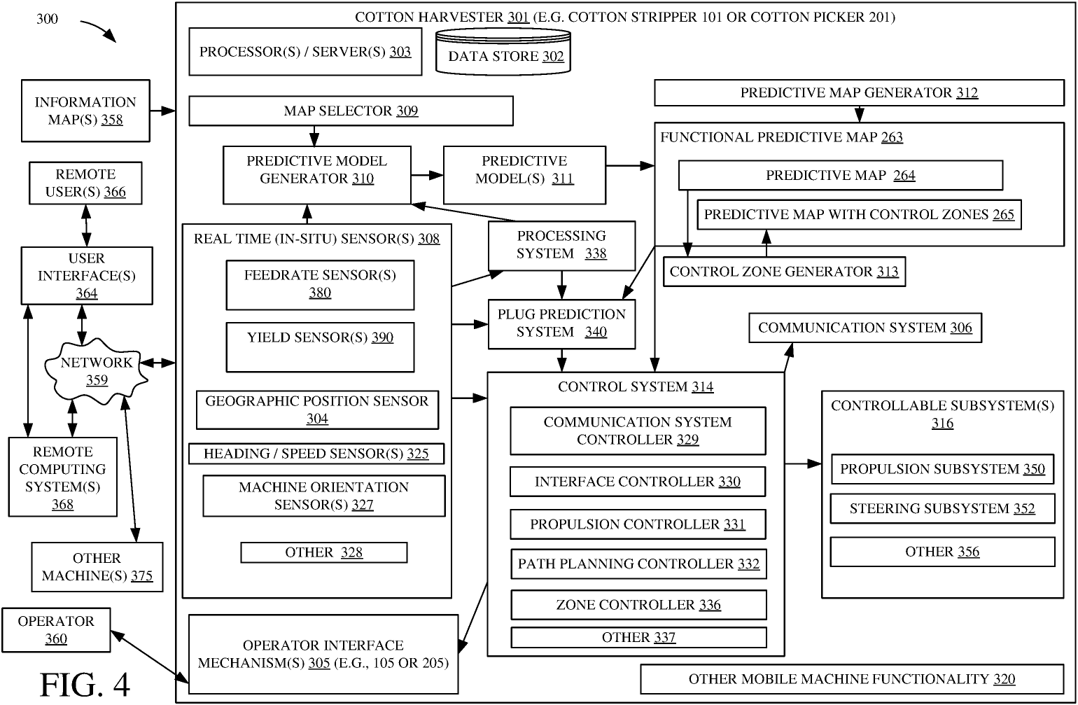

FIG. 4 is a block diagram showing some portions of an agricultural cotton harvesting system architecture 300. FIG. 4 shows that agricultural cotton harvesting system architecture 300 includes cotton harvester 301 (e.g., cotton stripper 101 or cotton picker 201), one or more remote computing systems 368, one or more remote user interfaces 364, network 359, and one or more information maps 358. Cotton harvester 301, itself, illustratively includes, data store 302, one or more processors or servers 303, communication system 306, one or more in-situ sensors 308 that sense one or more characteristics at a worksite concurrent with an operation, and a processing system 338 that processes the sensors signals generated by in-situ sensors 308 to generate processed sensor data. The in-situ sensors 308 generate values corresponding to the sensed characteristics. Cotton harvester 301 also includes a predictive model or relationship generator (collectively referred to hereinafter as “predictive model generator 310”) that generates a predictive model or relationship (collectively referred to hereinafter as “predictive model 311”), predictive map generator 312, control zone generator 313, control system 314, one or more controllable subsystems 316, and operator interface mechanisms 205. Cotton harvester 200 can also include a wide variety of other machine functionality 320.

The in-situ sensors 308 can be on-board cotton harvester 301, remote from cotton harvester 301, such as deployed at fixed locations on the worksite or on another machine operating in concert with cotton harvester 301, such as an aerial vehicle (e.g., UAV), and other types of sensors, or a combination thereof. In-situ sensors 308 sense characteristics of or at a worksite (e.g., field) during the course of an operation. In-situ sensors 308 illustratively include feedrate sensors 380, yield sensors 390, geographic position sensor 304, heading/speed sensors 325, machine orientation sensors 327, and can include various other sensors 328, including, but not limited to those discussed in previous FIGS.

Feedrate sensors 380 illustratively detect a feedrate (or value thereof) of crop through the cotton harvester as the cotton harvester 301 is harvesting at the worksite. Feedrate sensors 380 can utilize sensor data from one or more sensors, such as those discussed above in FIGS. 1-3. For example, feedrate sensors 380 can include one or more of mass flow sensors (e.g., 160, 162), accumulator fill level sensors (e.g., 224), load sensors, bale diameter sensors, weight sensors (e.g., load cells, strain gauges, etc.), moisture sensors, as well as a variety of other sensors.

Yield sensors 390 illustratively detect a yield (or value thereof) of crop harvested by cotton harvester 301 as the cotton harvester 301 is harvesting at the worksite. Yield sensors 390 can utilize sensor data from one or more sensors, such as those discussed above in FIGS. 1-3. For example, yield sensors 390 can include one or more of mass flow sensors (e.g., 160, 162), accumulator fill level sensors (e.g., 224), load sensors, bale diameter sensors, weight sensors (e.g., load cells, strain gauges, etc.), moisture sensors, as well as a variety of other sensors.

It will be understood that in some examples, the same sensor can be used to derive values of feedrate and yield. Thus, feedrate sensors 380 and yield sensors 390 can be the same sensor(s). In other examples, feedrate sensors 380 and yield sensors 390 are separate. In some examples, information provided by one sensor (e.g., feedrate sensor 380) may be used to derive values of a different characteristic (e.g., yield).

Geographic position sensor 304 illustratively senses or detects the geographic position or location of cotton harvester 301. Geographic position sensor 304 can include, but is not limited to, a global navigation satellite system (GNSS) receiver that receives signals from a GNSS satellite transmitter. Geographic position sensor 304 can also include a real-time kinematic (RTK) component that is configured to enhance the precision of position data derived from the GNSS signal. Geographic position sensor 304 can include a dead reckoning system, a cellular triangulation system, or any of a variety of other geographic position sensors.

Heading/speed sensors 325 detect a heading and speed at which cotton harvester 301 is traversing the worksite during the operation. This can include sensors that sense the movement of ground-engaging elements (e.g., 102, 202 or 104, 204) or can utilize signals received from other sources, such as geographic position sensor 304, thus, while heading/speed sensors 325 as described herein are shown as separate from geographic position sensor 304, in some examples, machine heading/speed is derived from signals received from geographic positions sensors and subsequent processing. In other examples, heading/speed sensors 325 are separate sensors and do not utilize signals received from other sources. Detecting a speed includes detecting a travel speed of cotton harvester 301 as well as detecting a change in the travel speed, that is the acceleration and deceleration of cotton harvester 301.

Machine orientation sensors 327 can include one or more inertial measurement units (IMUs) which can provide orientation information relative to cotton harvester 301, such as pitch, roll, and yaw data of cotton harvester 301. The one or more IMUs can include accelerometers, gyroscopes, and magnetometers.

Other in-situ sensors 328 may be any of the sensors described above with respect to previous FIGS. Other in-situ sensors 328 can be on-board cotton harvester 301 or can be remote from cotton harvester 301, such as other in-situ sensors 328 on-board another mobile machine that capture in-situ data of the worksite or sensors at fixed locations throughout the worksite. The remote data from remote sensors can be obtained by cotton harvester 301 (or by components of agricultural cotton harvesting system architecture 300) over network 359, such as via a communication system (e.g., 306).

In-situ data includes data taken from a sensor on-board the cotton harvester 301 or taken by any sensor where the data are detected during the operation of cotton harvester 301 at a worksite.

Processing system 338 processes the sensor data (e.g., signals, images, etc.) generated by in-situ sensors 308 to generate processed sensor data indicative of one or more characteristic values. For example, processing system generates processed sensor data indicative of characteristic values based on the sensor data generated by in-situ sensors, such as feedrate values based on sensor data generated by feedrate sensors 380, or yield values based on sensor data generated by yield sensors 390. Further examples include geographic position (location) values based on sensor data generated by geographic position sensor 304, machine orientation (pitch, roll, etc.) values based on sensor data generated by machine orientation sensors 327, machine speed (travel speed, acceleration, deceleration, etc.) values based on sensor data generated by heading/speed sensors 325 or geographic position sensor 304, machine heading values based on sensor data generated by heading/speed sensors 325 or geographic position sensor 304, as well as various other values based on sensors data generated by various other in-situ sensors 328.

It will be understood that processing system 338 can be implemented by one or more processers or servers, such as processors or servers 303. Additionally, processing system 338 can utilize various sensor signal filtering techniques, noise filtering techniques, sensor signal categorization, aggregation, normalization, as well as various other processing functionalities. Similarly, processing system 338 can utilize various image processing techniques such as, sequential image comparison, RGB color extraction, edge detection, black/white analysis, machine learning, neural networks, pixel testing, pixel clustering, shape detection, as well any number of other suitable image processing and data extraction functionalities.

FIG. 4 also shows that an operator 360 may operate and interact with cotton harvester 301. The operator 360 interacts with operator interface mechanisms 301 (e.g., 105 or 205). In some examples, operator interface mechanisms 305 may include joysticks, levers, a steering wheel, linkages, pedals, buttons, key fobs, wireless devices, such as mobile computing devices, dials, keypads, an interactive user interface display device which can include user actuatable elements (such as icons, buttons, etc.), a microphone (such as where speech recognition and speech synthesis are provided) and speaker, among a wide variety of other types of control devices, lights, as well as various other items. Where a touch sensitive display system is provided, operator 360 may interact with operator interface mechanisms 305 using touch gestures. Operator interface mechanisms 305 can provide, visible, audible, or haptic outputs. Some of the operator interface mechanisms 305 may be fixably coupled in the operator compartment of cotton harvester 301 while other operator interface mechanisms 301 are supported in the operator compartment and/or are communicably coupled to the cotton harvester 301, but may be mobile. These examples described above are provided as illustrative examples and are not intended to limit the scope of the present disclosure. Consequently, other types of operator interface mechanisms 305 may be used and are within the scope of the present disclosure.

FIG. 4 also shows remote users 366 interacting with cotton harvester 301 or remote computing systems 368, or both, through user interface mechanisms 364 over network 359. User interface mechanisms 364 may include joysticks, levers, a steering wheel, linkages, pedals, buttons, key fobs, wireless devices, such as mobile computing devices, dials, keypads, an interactive user interface display device which can include user actuatable elements (such as icons, buttons, etc.), a microphone (such as where speech recognition and speech synthesis are provided) and speaker, among a wide variety of other types of control devices, lights, as well as various other items. User interface mechanisms 364 can provide, visible, audible, or haptic outputs. These examples described above are provided as illustrative examples and are not intended to limit the scope of the present disclosure. Consequently, other types of user interface mechanisms 364 may be used and are within the scope of the present disclosure.

Remote computing systems 368 can be a wide variety of different types of systems, or combinations thereof. For example, remote computing systems 368 can be in a remote server environment. Further, remote computing systems 368 can be remote computing systems, such as mobile devices, a remote network, a farm manager system, a vendor system, or a wide variety of other remote systems. In one example, cotton harvester 301 can be controlled remotely by remote computing systems or by remote users 366, or both. As will be described below, in some examples, one or more of the components shown being disposed on cotton harvester 301 in FIG. 4 can be located elsewhere, such as at remote computing systems 368.

Control system 314 includes communication system controller 329, interface controller 330, propulsion controller 331, path planning controller 332, zone controller 336, and control system 314 can include other items 337. Controllable subsystems 316 include propulsion subsystem 350, steering subsystem 352, and subsystem 316 can include a wide variety of other subsystems 356.

FIG. 4 also shows that cotton harvester 301 can obtain one or more information maps 358. As described herein, the information maps 358 include, for example, a vegetative index map, a yield map, a prior product application operation map, a prior irrigation operation map, a soil moisture map, a soil type map, a historical feedrate map, and an optical characteristic map. However, information maps 358 may also encompass other types of data, such as other types of data that were obtained prior to a harvesting operation or a map from a prior operation. In other examples, information maps 358 can be generated during a current operation, such a map generated by predictive map generator 312 based on a predictive model 311 generated by predictive model generator 310.

Information maps 358 may be downloaded onto cotton harvester 301 over network 359 and stored in data store 302, using communication system 306 or in other ways. In some examples, communication system 306 may be a cellular communication system, a system for communicating over a wide area network or a local area network, a system for communicating over a near field communication network, or a communication system configured to communicate over any of a variety of other networks or combinations of networks, including a variety of other wired or wireless networks. Network 359 illustratively represents any or a combination of any of the variety of networks. Communication system 306 may also include a system that facilitates downloads or transfers of information to and from a secure digital (SD) card or a universal serial bus (USB) card or both.

In some examples, information maps 358 can be downloaded onto remote computing systems 368 or user interface mechanisms 364, or both, over network 359. In a particular example, as will be shown below, one or more of predictive model generator 310, predictive map generator 312, and control zone generator 313, among other things, may be located remotely from cotton harvester 301, such as at remote computing systems 368. In such an example, prior information maps 358 may be obtained by the remote computing systems 368 over network 358.

Information maps 358 can be provided to cotton harvester 301, or to other systems, or both, in a variety of other ways as well.

Predictive model generator 310 generates a model that is indicative of a relationship between the value(s) sensed by the in-situ sensors 308 and value(s) mapped to the field by the information maps 358. For example, if the information map 358 maps a value (e.g., vegetative index value, yield value, prior product application operation characteristic value, prior irrigation operation characteristic value, soil moisture value, soil type value, historical feedrate value, optical characteristic value, or another mapped characteristic value) to different locations in the worksite, and the in-situ sensor 308 is detecting feedrate values, then model generator 310 generates a predictive feedrate model that models the relationship between the mapped values and feedrate values. In another example, if the information map 358 maps a value (e.g., vegetative index value, yield value, prior product application operation characteristic value, prior irrigation operation characteristic value, soil moisture value, soil type value, historical feedrate value, optical characteristic value, or another mapped characteristic value) to different locations in the worksite, and the in-situ sensor 308 is detecting yield values, then model generator 310 generates a predictive yield model that models the relationship between the mapped values and yield.

In some examples, the predictive map generator 312 uses the predictive models generated by predictive model generator 310 to generate functional predictive maps that predict the value of one or more characteristics, such as feedrate or yield, sensed by the in-situ sensors 308 at different locations in the worksite based upon one or more of the information maps 358. For example, where the predictive model is a predictive feedrate model that models a relationship between feedrate sensed by one or more in-situ sensors 308 and one or more of vegetative index values from a vegetative index map, yield values from a yield map, prior product application operation characteristic values form a prior product application operation map, prior irrigation operation characteristic values from a prior irrigation operation map, soil moisture values from a soil moisture map, soil type values from a soil type map, historical feedrate values from a historical feedrate map, optical characteristic values from an optical characteristic map, and other mapped characteristic values from another map, then predictive map generator 312 generates a functional predictive feedrate map that predicts feedrate values at different locations at the worksite based on one or more of the vegetative index values from a vegetative index map, yield values from a yield map, prior product application operation characteristic values from a prior product application operation map, prior irrigation operation characteristic values from a prior irrigation operation map, soil moisture values from a soil moisture map, soil type values from a soil type map, historical feedrate values from a historical feedrate map, optical characteristic values from an optical characteristic map, and other mapped characteristic values from another map at those locations and the predictive feedrate model.

In another example, where the predictive model is a predictive yield model that models a relationship between yield sensed by one or more in-situ sensors 308 and one or more of vegetative index values from a vegetative index map, yield values from a yield map, prior product application operation characteristic values form a prior product application operation map, prior irrigation operation characteristic values from a prior irrigation operation map, soil moisture values from a soil moisture map, soil type values from a soil type map, historical feedrate values from a historical feedrate map, optical characteristic values from an optical characteristic map, and other mapped characteristic values from another map, then predictive map generator 312 generates a functional predictive yield map that predicts yield values at different locations at the worksite based on one or more of the vegetative index values from a vegetative index map, yield values from a yield map, prior product application operation characteristic values from a prior product application operation map, prior irrigation operation characteristic values from a prior irrigation operation map, soil moisture values from a soil moisture map, soil type values from a soil type map, historical feedrate values from a historical feedrate map, optical characteristic values from an optical characteristic map, and other mapped characteristic values from another map at those locations and the predictive yield model.

It will be understood that functional predictive map 263 encompasses the various functional predictive maps that can be generated by predictive map generator 312.

In some examples, the type of values in the functional predictive map 263 may be the same as the in-situ data type sensed by the in-situ sensors 308. In some instances, the type of values in the functional predictive map 263 may have different units from the data sensed by the in-situ sensors 308. In some examples, the type of values in the functional predictive map 263 may be different from the data type sensed by the in-situ sensors 308 but have a relationship to the type of data type sensed by the in-situ sensors 308. For example, in some examples, the data type sensed by the in-situ sensors 308 may be indicative of the type of values in the functional predictive map 263. In some examples, the type of data in the functional predictive map 263 may be different than the data type in the information maps 358. In some instances, the type of data in the functional predictive map 263 may have different units from the data in the information maps 358. In some examples, the type of data in the functional predictive map 263 may be different from the data type in the information map 358 but has a relationship to the data type in the information map 358. For example, in some examples, the data type in the information maps 358 may be indicative of the type of data in the functional predictive map 263. In some examples, the type of data in the functional predictive map 263 is different than one of, or both of, the in-situ data type sensed by the in-situ sensors 308 and the data type in the information maps 358. In some examples, the type of data in the functional predictive map 263 is the same as one of, or both of, of the in-situ data type sensed by the in-situ sensors 308 and the data type in information maps 358. In some examples, the type of data in the functional predictive map 263 is the same as one of the in-situ data type sensed by the in-situ sensors 308 or the data type in the information maps 358, and different than the other.

As shown in FIG. 4, predictive map 264 predicts the value of a sensed characteristic (sensed by in-situ sensors 308), or a characteristic related to (e.g., derived from) the sensed characteristic, at various locations across the worksite based upon one or more information values in one or more information maps 358 at those locations and using the predictive model 311. For example, if predictive model generator 310 has generated a predictive model 311 indicative of a relationship between one or more mapped characteristics values (e.g., vegetative index values, yield values, prior product application operation characteristic values, prior irrigation operation characteristic values, soil moisture values, soil type values, historical feedrate values, optical characteristic values, and other mapped characteristic values) and feedrate values, then, given the one or more mapped characteristics values at different locations across the worksite, predictive map generator 312 generates a predictive map 264 that predicts feedrate values at different locations across the worksite. The one or more mapped characteristics values, obtained from the respective information maps, at those locations and the relationship between the one or more mapped characteristics values and feedrate values, obtained from the predictive model 311, are used to generate the predictive map 264.

In another example, if predictive model generator 310 has generated a predictive model 311 indicative of a relationship between one or more mapped characteristics values (e.g., vegetative index values, yield values, prior product application operation characteristic values, prior irrigation operation characteristic values, soil moisture values, soil type values, historical feedrate values, optical characteristic values, and other mapped characteristic values) and yield values, then, given the one or more mapped characteristics values at different locations across the worksite, predictive map generator 312 generates a predictive map 264 that predicts yield values at different locations across the worksite. The one or more mapped characteristics values, obtained from the respective information maps, at those locations and the relationship between the one or more mapped characteristics values and yield values, obtained from the predictive model 311, are used to generate the predictive map 264.

These are merely some examples. Various other information maps can be used to generate relationships between the other mapped values and feedrate values to generate a predictive feedrate map. Similarly, various other information maps can be used to generate relationships between the other mapped values and yield values to generate a predictive yield map.

Some variations in the data types that are mapped in the information maps 358, the data types sensed by in-situ sensors 308, and the data types predicted on the predictive map 264 will now be described.

In some examples, the data type in one or more information maps 358 is different from the data type sensed by in-situ sensors 308, yet the data type in the predictive map 264 is the same as the data type sensed by the in-situ sensors 308. For instance, the information map 358 may be a vegetative index map, and the variable sensed by the in-situ sensors 308 may be yield or feedrate. The predictive map 264 may then be a predictive yield map that maps predicted yield values to different geographic locations in the in the worksite or a predictive feedrate map that maps predicted feedrate values to different geographic locations in the worksite.

Also, in some examples, the data type in the information map 358 is different from the data type sensed by in-situ sensors 308, and the data type in the predictive map 264 is different from both the data type in the information map 358 and the data type sensed by the in-situ sensors 308.

In some examples, the information map 358 is from a prior pass through the field during a prior operation and the data type is different from the data type sensed by in-situ sensors 308, yet the data type in the predictive map 264 is the same as the data type sensed by the in-situ sensors 308. For instance, the information map 358 may be a prior product application operation map generated during a previous product application operation on the worksite in the same year (or same season), and the variable sensed by the in-situ sensors 308 may be feedrate or yield. The predictive map 264 may then be a predictive feedrate map that maps predicted feedrate values to different geographic locations in the worksite or a predictive yield map that maps predicted yield values to different geographic locations in the worksite. In another example, the information map 358 may be a prior irrigation operation map generated during a previous irrigation operation on the worksite, and the variable sensed by the in-situ sensors 308 may be feedrate or yield. The predictive map 264 may then be a predictive feedrate map that maps predicted feedrate values to different geographic locations in the worksite or a predictive yield map that maps predicted yield values to different geographic locations in the worksite.

In some examples, the information map 358 is from a prior pass through the field during a prior operation and the data type is the same as the data type sensed by in-situ sensors 308, and the data type in the predictive map 264 is also the same as the data type sensed by the in-situ sensors 308. For instance, the information map 358 may be a feedrate map generated during a previous year (e.g., historical feedrate map), and the variable sensed by the in-situ sensors 308 may be feedrate. The predictive map 264 may then be a predictive feedrate map that maps predicted feedrate values to different geographic locations in the field. In such an example, the relative feedrate differences in the georeferenced information map 358 from the prior year can be used by predictive model generator 310 to generate a predictive model that models a relationship between the relative feedrate differences on the information map 358 and the feedrate values sensed by in-situ sensors 308 during the current operation. The predictive model is then used by predictive map generator 312 to generate a predictive feedrate map.

In another example, the information map 358 may be from a prior pass through the field during a prior operation and the data type is different from the data type sensed by in-situ sensors 308, and the data type in the predictive map 264 is the same as the data type sensed by the in-situ sensors. For instance, the information map may be a yield map generated during a prior operation in a previous year (e.g., a historical yield map), and the variable sensed by the in-situ sensors 308 may be feedrate. The predictive map 264 may then be a predictive feedrate map that maps predicted feedrate values to different geographic locations in the field.

In some examples, predictive map 264 can be provided to the control zone generator 313. Control zone generator 313 groups adjacent portions of an area into one or more control zones based on data values of predictive map 264 that are associated with those adjacent portions. A control zone may include two or more contiguous portions of a worksite, such as a field, for which a control parameter corresponding to the control zone for controlling a controllable subsystem is constant. For example, a response time to alter a setting of controllable subsystems 316 may be inadequate to satisfactorily respond to changes in values contained in a map, such as predictive map 264. In that case, control zone generator 313 parses the map and identifies control zones that are of a defined size to accommodate the response time of the controllable subsystems 316. In another example, control zones may be sized to reduce wear from excessive actuator movement resulting from continuous adjustment. In some examples, there may be a different set of control zones for each controllable subsystem 316 or for groups of controllable subsystems 316. The control zones may be added to the predictive map 264 to obtain predictive control zone map 265. Predictive control zone map 265 can thus be similar to predictive map 264 except that predictive control zone map 265 includes control zone information defining the control zones. Thus, a functional predictive map 263, as described herein, may or may not include control zones. Both predictive map 264 and predictive control zone map 265 are functional predictive maps 263. In one example, a functional predictive map 263 does not include control zones, such as predictive map 264. In another example, a functional predictive map 263 does include control zones, such as predictive control zone map 265. In some examples, multiple crops (e.g., intercropping), or multiple crop genotypes, such as various hybrids of the same crop, may be simultaneously present in a field. In that case, predictive map generator 312 and control zone generator 313 are able to identify the location and characteristics of the two or more crops species, or two or more crop genotypes, and then generate predictive map 264 and predictive map with control zones 265 accordingly.

It will also be appreciated that control zone generator 313 can cluster values to generate control zones and the control zones can be added to predictive map 264 to generate a predictive map with control zone 265, or a separate map, showing only the control zones that are generated. In some examples, the control zones may be used for controlling or calibrating cotton harvester 301 or both. In other examples, the control zones may be presented to the operator 360 or user 366 and used to control or calibrate cotton harvester 301, and, in other examples, the control zones may be presented to the operator 360 or another user, such as a remote user 366, or stored for later use.

In some examples, control zone generator 313 can cluster predictive values, such as predictive feedrate values, into high feedrate zones and low feedrate zones. The clustering can be based on a threshold. For example, predictive feedrate values at or exceeding (e.g., above) a threshold value (e.g., threshold feedrate value) may be grouped into high feedrate zones. Predictive feedrate values at or exceeding (e.g., below) a threshold value (e.g., a threshold feedrate value) may be grouped into low feedrate zones. Thus, in one example, a predictive control zone map 265 can include, as control zones, high feedrate control zones and low feedrate control zones. The threshold value(s) can be pre-set, provided by an operator or user, output by the control system, or provided in various other ways. In another examples, control zone generator 313 can cluster predictive values, such as predictive yield values, into high yield zones and low yield zones. The clustering can be based on a threshold. For example, predictive yield values at or exceeding (e.g., above) a threshold value (e.g., threshold yield value) may be grouped into high yield zones. Predictive yield values at or exceeding (e.g., below) a threshold value (e.g., a threshold yield value) may be grouped into low yield zones. Thus, in one example, a predictive control zone map 265 can include, as control zones, high yield control zones and low yield control zones. The threshold value(s) can be pre-set, provided by an operator or user, output by the control system, or provided in various other ways.

Predictive map 264 or predictive control zone map 265 or both are provided to control system 314, which generates control signals based upon the predictive map 264 or predictive control zone map 265 or both. In some examples, communication system controller 329 controls communication system 306 to communicate the predictive map 264 or predictive control zone map 265 or control signals based on the predictive map 264 or predictive control zone map 265 to other mobile machines 375 that are operating at the same worksite or in the same operation. In some examples, communication system controller 329 controls the communication system 306 to send the predictive map 264, predictive control zone map 265, or both, to other remote systems, such as remote computing systems 368 or remote user interface mechanisms 364, or both.

Interface controller 330 is operable to generate control signals to control interface mechanisms, such as operator interface mechanisms 305 or user interfaces 364, or both. The interface controller 330 is also operable to present the predictive map 264 or predictive control zone map 265 or other information derived from or based on the predictive map 264, predictive control zone map 265, or both, to operator 360 or a remote user 366, or both. Operator 360 may be a local operator or a remote operator. As an example, interface controller 330 generates control signals to control a display mechanism (e.g., 305 and/or 364) to display one or both of predictive map 264 and predictive control zone map 265 for the operator 360 or a remote user 366, or both. Interface controller 330 may generate operator or user actuatable mechanisms that are displayed and can be actuated by the operator or user to interact with the displayed map. The operator or user can edit the map by, for example, correcting a value displayed on the map, based on, for example, the operator’s or the user’s observation or desire.

Path planning controller 332 illustratively generates control signals to control steering subsystem 352 to steer cotton harvester 301 according to a desired path or according to desired parameters, such as desired steering angles based on one or more of the predictive map 264, the predictive control zone map 265, and the predictive model 311. Path planning controller 332 can control a path planning system to generate a route for cotton harvester 301 and can control propulsion subsystem 350 and steering subsystem 352 to steer cotton harvester 301 along that route. In one example, the predictive control zone map 265 may include, as control zones, high feedrate control zones and low feedrate control zones. Path planning controller 332 can generate a route for cotton harvester 301 based on the high feedrate control zones and low feedrate control zones. For example, path planning controller 332 can generate a route for cotton harvester 301 that reduces the transitions from low feedrate control zones to high feedrate control zones or that increases the transitions from high feedrate control zones to low feedrate control zones, or both. In another example, the predictive control zone map 265 may include, as control zones, high yield control zones and low yield control zones. Path planning controller 332 can generate a route for cotton harvester 301 based on the high yield control zones and low yield control zones. For example, path planning controller 332 can generate a route for cotton harvester 301 that reduces the transitions from low yield control zones to high yield control zones or that increases the transitions from high yield control zones to low yield control zones, or both.

Propulsion controller 331 illustratively generates control signals to control propulsion subsystem 350 to control a speed characteristic of cotton harvester 200, such as one or more of travel speed, acceleration, and deceleration, based on one or more of the predictive map 264, the predictive control zone map 265, and the predictive model 311. Propulsion subsystem can include a power plant (e.g., 108 or 208), ground engaging elements (e.g., 102 and 104 or 202 and 204), transmission, axles, as well as various other powertrain components.

Zone controller 336 illustratively generates control signals to control one or more controllable subsystems 316 to control operation of the one or more controllable subsystems based on the predictive control zone map 265.

Other controllers 337 included on the cotton harvester 301, or at other locations in agricultural system 300, can control other subsystems based on the predictive map 264 or predictive control zone map 265 or both as well.

In some examples, predictive map 264 or predictive map with control zones 265, or both, are provided to plug prediction system 340. Plug prediction system 340 also obtains threshold values, such as from data store or otherwise provided by an operator or user. Based on the predictive map 264 or predictive map with control zones 265, or both, and the threshold value, plug prediction system 340 can determine the likelihood of plugging on cotton harvester 301 at areas of the field ahead of cotton harvester 301 and can provide a plug prediction output indicative of the likely plugging at areas of the field ahead of cotton harvester 301. The plug prediction output can be provided to control system 314 where interface controller 330 can generate control signals to control an interface mechanism (e.g., 305, 364, etc.) to generate a display, alert, recommendation, notification, or other indication of likely plugging to an operator 360 or user 366, or both. In some examples, communication system controller 329 can control communication system 306 to provide the plug prediction output to other systems, such as other mobile machines 375, remote computing systems 368, and/or user interface mechanisms 364. Further, based on the plug prediction output, one or more of the other controllers of control system 314 can control other subsystems, for instance, propulsion controller 331 can control propulsion subsystem 350 to change the speed of cotton harvester 301 when operating at the areas of the field where plugging is likely.

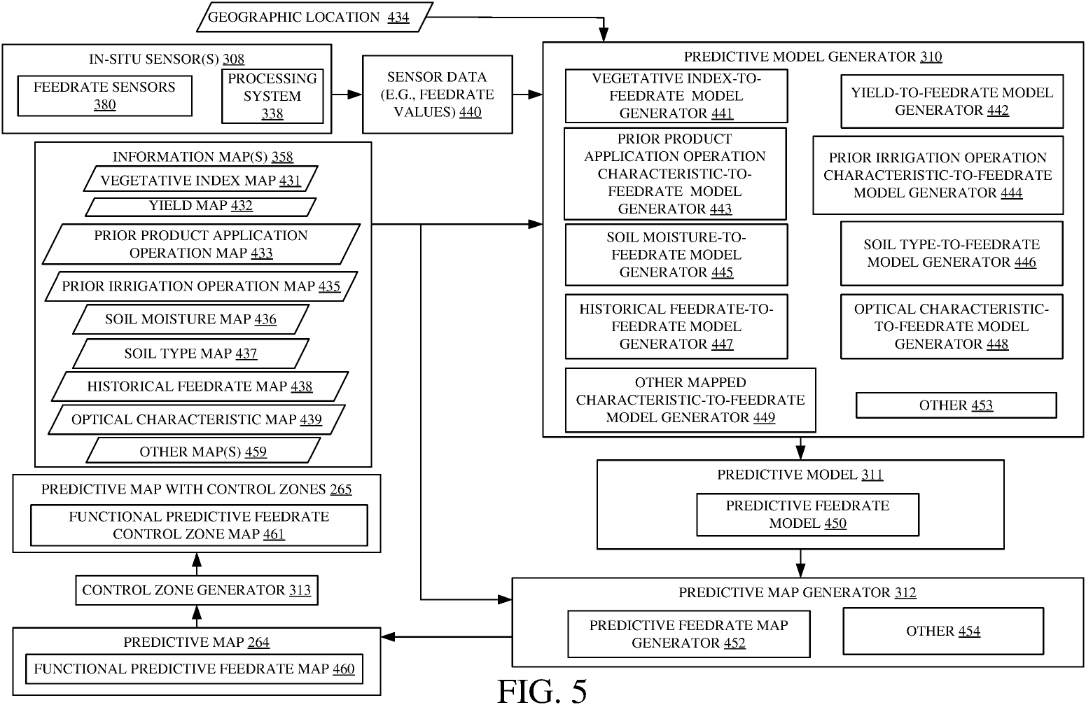

As an illustrative example, predictive map 264 and predictive map with control zones 265 may be in the form of a functional predictive feedrate map (e.g., 460 in FIG. 5) and a functional predictive feedrate control zone map (e.g., 461 in FIG. 5), respectively. Thus, the map(s) will contain georeferenced predictive values of feedrate at different locations across the worksite. The threshold value utilized by plug prediction system 340 may be a threshold feedrate value. Thus, for a given location at the field, plug prediction system 340 can determine plugging is likely to occur based on the predictive feedrate value (as provided by the map(s)) for that given location and the threshold feedrate value. That is, plug prediction system 340 can determine that plugging is likely to occur at a given location where the predictive feedrate value for the given location exceeds (e.g., is below) the threshold feedrate value. Plug prediction system 340 can provide a plug prediction output indicating the likely plugging at the given location. Communication system controller 330 can generate control signals to control communication system 306 to communicate the plug prediction output to other systems. Interface controller 331 can generate control signals to control one or more interface mechanisms (e.g., 305, 364, etc.) to generate a display, alert, recommendation, notification, or other indication to an operator 360 or user 366, or both. Propulsion controller 331 can generate control signals to control propulsion subsystem 350 to change a speed of cotton harvester 301 when operating at the given location. A combination of the above controls can also occur, for instance, a display, alert, recommendation, notification or other indication can be generated, the speed of the cotton harvester 301 can be adjusted, and other systems, such as other machines 375, remote computing systems 368, and/or user interface mechanisms 364 can be provided with information that the speed of cotton harvester 301 has been adjusted. These are merely some examples.

While the illustrated example of FIG. 4 shows that various components of agricultural cotton harvesting system architecture 300 are located on cotton harvester 301, it will be understood that in other examples one or more of the components illustrated on cotton harvester 301 in FIG. 4 can be located at other locations, such as one or more remote computing systems 368 and/or user interface mechanisms 364. For instance, one or more of map selector 309, predictive model generator 310, predictive model 311, predictive map generator 312, functional predictive maps 263 (e.g., 264 and 265), and control zone generator 313 can be located remotely from cotton harvester 301 but can communicate with cotton harvester 301 via communication system 306 and network 359. Thus, the predictive models 311 and functional predictive maps 263 may be generated at remote locations away from cotton harvester 301 and can be communicated to cotton harvester 301 over network 359, for instance, communication system 306 can download the predictive models 311 or functional predictive maps 263, or both, from the remote locations and store them in data store 302. In other examples, cotton harvester 301 may access the predictive models 311 and functional predictive maps 263 at the remote locations without storing the predictive models 311 and functional predictive maps 263. The information used in the generation of the predictive models 311 and functional predictive maps 263 may be provided to the predictive model generator 310 and the predictive map generator 312 at those remote locations over network 359, for example in-situ sensor data generator by in-situ sensors 308 can be provided over network 359 to the remote locations. Similarly, information maps 358 can be provided to the remote locations. These are merely some examples.

In some examples, control system 314 (or another control system) can be located remotely from cotton harvester 301 such that cotton harvester can be controlled from a remote location, such as remote computing systems 368 or user interfaces 364, or both, or another location. In other examples, control system 314 can be located on cotton harvester 301 while another control system, or control output generator, is located at a remote location and the outputs from the remote location can be communicated to control harvester 301 and used by control system 314, on the cotton harvester 301, to control cotton harvester 301. These are merely some examples.

FIG. 5 is a block diagram of a portion of the agricultural cotton harvesting system architecture 300 shown in FIG. 4. Particularly, FIG. 5 shows, among other things, examples of the predictive model generator 310 and the predictive map generator 312 in more detail. FIG. 5 also illustrates information flow among the various components shown. The predictive model generator 310 receives one or more of a vegetative index map 431, a yield map 432, prior product application operation map 433, a prior irrigation operation map 435, a soil moisture map 436, a soil type map 437, a historical feedrate map 438, an optical characteristic map 439, and another type of map 459. Predictive model generator 310 also receives a geographic location 434, or an indication of a geographic location, from geographic positions sensor 304. In some examples, the geographic location of the cotton harvester 301 and the geographic location of the variable detected by in-situ sensors 308 are not the same, for instance, the location, to which the feedrate value may be attributed, may be located behind the agricultural harvester (or header) at the time the feedrate is sensed. For example, the location of the cotton harvester 301 at the time a signal from the in-situ sensor is received may not be the accurate location to which the feedrate can be attributed. This is because an amount of time elapses between when the cotton harvester makes initial contact with the crop plant and when the feedrate resulting from the crop plant is sensed. Thus, a transient time between when the crop is encountered by the cotton harvester and when the feedrate is sensed is taken into account when georeferencing the sensed data. Thus, a combination of the timing of the detection, the position of the respective sensor, the geographic location of the agricultural harvester, the speed and heading of the cotton harvester may be used to derive the corresponding geographic location of the feedrate value. In either case, geographic location 434 indicates a geographic location on the worksite to which a respective feedrate value corresponds.

In-situ sensors 308 illustratively include feedrate sensors 380, as well as a processing system 338. In some instances, feedrate sensors 380 may be located on-board cotton harvester 301. In the illustrated example of FIG. 5, processing system 338 processes sensor data generated from feedrate sensors 380 to generate processed sensor data 440 indicative of feedrate values. While the processing system 338 is illustrated as part of in-situ sensors 308 in FIG. 5, in other examples processing system 338 can be separate from but in operable communication with in-situ sensors 308, such as the example shown in FIG. 4.

As shown in FIG. 5, the example predictive model generator 310 includes, as examples of predictive model generators 311, one or more of a vegetative index-to-feedrate model generator 441, a yield-to-feedrate model generator 442, a prior product application operation characteristic-to-feedrate model generator 443, a prior irrigation operation characteristic-to-feedrate model generator 444, a soil moisture-to-feedrate model generator 445, a soil type-to-feedrate model generator 446, a historical feedrate-to-feedrate model generator 447, an optical characteristic-to-feedrate model generator 448, and an other mapped characteristic-to-feedrate model generator 449. In other examples, the predictive model generator 310 may include additional, fewer, or different components than those shown in the example of FIG. 5. Consequently, in some examples, the predictive model generator 310 may include other items 453 as well, which may include other types of predictive model generators to generate other types of models, such as other types of feedrate models.

Vegetative index-to-feedrate model generator 441 identifies a relationship between feedrate values detected in in-situ sensor data 440 and vegetative index values from the vegetative index map 431 corresponding to the same locations to which the detected feedrate values correspond. Based on this relationship established by vegetative index-to-feedrate model generator 441, vegetative index-to-feedrate model generator 441 generates a predictive feedrate model. The predictive feedrate model is used by feedrate map generator 452 to predict values of feedrate (or the sensor values indicative of feedrate values) at different locations in the worksite based upon the georeferenced vegetative index values contained in the vegetative index map 431 at those different locations in the worksite. Thus, for a given location in the worksite, feedrate can be predicted at the given location based on the predictive feedrate model generated by vegetative index-to-feedrate model generator 441 and the vegetative index value, from the vegetative index map 431, at that given location.

Yield-to-feedrate model generator 442 identifies a relationship between feedrate values detected in in-situ sensor data 440 and yield values from the yield map 432 corresponding to the same locations to which the detected feedrate values correspond. Based on this relationship established by yield-to-feedrate model generator 442, yield-to-feedrate model generator 442 generates a predictive feedrate model. The predictive feedrate model is used by feedrate map generator 452 to predict values of feedrate (or the sensor values indicative of feedrate values) at different locations in the worksite based upon the georeferenced yield values contained in the yield map 432 at those different locations in the worksite. Thus, for a given location in the worksite, feedrate can be predicted at the given location based on the predictive feedrate model generated by yield-to-feedrate model generator 442 and the yield value, from the yield map 432, at that given location.

Prior product application operation characteristic-to-feedrate model generator 443 identifies a relationship between feedrate values detected in in-situ sensor data 440 and prior product application operation characteristic values from the prior product application operation map 433 corresponding to the same locations to which the detected feedrate values correspond. Based on this relationship established by prior product application operation characteristic-to-feedrate model generator 443, prior product application operation characteristic-to-feedrate model generator 443 generates a predictive feedrate model. The predictive feedrate model is used by feedrate map generator 452 to predict values of feedrate (or the sensor values indicative of feedrate values) at different locations in the worksite based upon the georeferenced prior product application operation characteristic values contained in the prior product application operation map 433 at those different locations in the worksite. Thus, for a given location in the worksite, feedrate can be predicted at the given location based on the predictive feedrate model generated by prior product application operation characteristic-to-feedrate model generator 443 and the prior product application operation characteristic value, from the prior product application operation map 433, at that given location.

Prior irrigation operation characteristic-to-feedrate model generator 444 identifies a relationship between feedrate values detected in in-situ sensor data 440 and prior irrigation operation characteristic values from the prior irrigation operation map 435 corresponding to the same locations to which the detected feedrate values correspond. Based on this relationship established by prior irrigation operation characteristic-to-feedrate model generator 444, prior irrigation operation characteristic-to-feedrate model generator 444 generates a predictive feedrate model. The predictive feedrate model is used by feedrate map generator 452 to predict values of feedrate (or the sensor values indicative of feedrate values) at different locations in the worksite based upon the georeferenced prior irrigation operation characteristic values contained in the prior irrigation operation map 435 at those different locations in the worksite. Thus, for a given location in the worksite, feedrate can be predicted at the given location based on the predictive feedrate model generated by prior irrigation operation characteristic-to-feedrate model generator 444 and the prior irrigation operation characteristic value, from the prior irrigation operation map 435, at that given location.

Soil moisture-to-feedrate model generator 445 identifies a relationship between feedrate values detected in in-situ sensor data 440 and soil moisture values from the soil moisture map 436 corresponding to the same locations to which the detected feedrate values correspond. Based on this relationship established by soil moisture-to-feedrate model generator 445, soil moisture-to-feedrate model generator 445 generates a predictive feedrate model. The predictive feedrate model is used by feedrate map generator 452 to predict values of feedrate (or the sensor values indicative of feedrate values) at different locations in the worksite based upon the georeferenced soil moisture values contained in the soil moisture map 436 at those different locations in the worksite. Thus, for a given location in the worksite, feedrate can be predicted at the given location based on the predictive feedrate model generated by soil moisture-to-feedrate model generator 445 and the soil moisture value, from the soil moisture map 436, at that given location.

Soil type-to-feedrate model generator 446 identifies a relationship between feedrate values detected in in-situ sensor data 440 and soil type values from the soil type map 437 corresponding to the same locations to which the detected feedrate values correspond. Based on this relationship established by soil type-to-feedrate model generator 446, soil type-to-feedrate model generator 446 generates a predictive feedrate model. The predictive feedrate model is used by feedrate map generator 452 to predict values of feedrate (or the sensor values indicative of feedrate values) at different locations in the worksite based upon the georeferenced soil type values contained in the soil type map 437 at those different locations in the worksite. Thus, for a given location in the worksite, feedrate can be predicted at the given location based on the predictive feedrate model generated by soil type-to-feedrate model generator 446 and the soil type value, from the soil type map 437, at that given location.

Historical feedrate-to-feedrate model generator 447 identifies a relationship between feedrate values detected in in-situ sensor data 440 and historical feedrate values from the historical feedrate map 438 corresponding to the same locations to which the detected feedrate values correspond. Based on this relationship established by historical feedrate-to-feedrate model generator 447, historical feedrate-to-feedrate model generator 447 generates a predictive feedrate model. The predictive feedrate model is used by feedrate map generator 452 to predict values of feedrate (or the sensor values indicative of feedrate values) at different locations in the worksite based upon the georeferenced historical feedrate values contained in the historical feedrate map 438 at those different locations in the worksite. Thus, for a given location in the worksite, feedrate can be predicted at the given location based on the predictive feedrate model generated by historical feedrate-to-feedrate model generator 447 and the historical feedrate value, from the historical feedrate map 438, at that given location.

Optical characteristic-to-feedrate model generator 448 identifies a relationship between feedrate values detected in in-situ sensor data 440 and optical characteristic values from the optical characteristic map 439 corresponding to the same locations to which the detected feedrate values correspond. Based on this relationship established by optical characteristic-to-feedrate model generator 448, optical characteristic-to-feedrate model generator 448 generates a predictive feedrate model. The predictive feedrate model is used by feedrate map generator 452 to predict values of feedrate (or the sensor values indicative of feedrate values) at different locations in the worksite based upon the georeferenced optical characteristic values contained in the optical characteristic map 438 at those different locations in the worksite. Thus, for a given location in the worksite, feedrate can be predicted at the given location based on the predictive feedrate model generated by optical characteristic-to-feedrate model generator 448 and the optical characteristic value, from the optical characteristic map 439, at that given location.

Other mapped characteristic-to-feedrate model generator 449 identifies a relationship between feedrate values detected in in-situ sensor data 440 and other mapped characteristic values from an other map 459 corresponding to the same locations to which the detected feedrate values correspond. Based on this relationship established by other mapped characteristic-to-feedrate model generator 449, other mapped characteristic-to-feedrate model generator 449 generates a predictive feedrate model. The predictive feedrate model is used by feedrate map generator 452 to predict values of feedrate (or the sensor values indicative of feedrate values) at different locations in the worksite based upon the georeferenced other characteristic values contained in the other map 459 at those different locations in the worksite. Thus, for a given location in the worksite, feedrate can be predicted at the given location based on the predictive feedrate model generated by other mapped characteristic-to-feedrate model generator 449 and the other characteristic value, from the other map 459, at that given location.

In light of the above, the predictive model generator 310 is operable to produce a plurality of predictive feedrate models, such as one or more of the predictive feedrate models generated by model generators 441, 442, 443, 444, 445, 446, 447, 448, 449, and 453. In another example, two or more of the predictive models described above may be combined into a single predictive feedrate model, such as a predictive feedrate model that predicts feedrate based upon two or more of vegetative index values, yield values, prior product application operation characteristic values, prior irrigation operation characteristic values, soil moisture values, soil type values, historical feedrate values, optical characteristic values, and the other characteristic values at different locations in the field. Any of these feedrate models, or combinations thereof, are represented collectively by predictive feedrate model 450 in FIG. 5. Predictive feedrate model 450 is an example of a predictive model 311.

The predictive feedrate model 450 is provided to predictive map generator 312. In the example of FIG. 5, predictive map generator 312 includes a feedrate map generator 452. In other examples, predictive map generator 312 may include additional or different map generators. Thus, in some examples, predictive map generator 312 may include other items 454 which may include other types of map generators to generate other types of maps.

Feedrate map generator 452 receives one or more of the vegetative index map 431, the yield map 432, the prior product application operation map 433, the prior irrigation operation map 435, the soil moisture map 436, the soil type map 437, the historical feedrate map 438, the optical characteristic map 439, and another type of map 459, along with the predictive feedrate model 450 which predicts values of feedrate based upon one or more of vegetative index values, yield values, prior product application operation characteristic values, prior irrigation operation characteristic values, soil moisture values, soil type values, historical feedrate values, optical characteristic values, and the other mapped characteristic values and generates a predictive feedrate map that predicts feedrate at different locations in the worksite.

Predictive map generator 312 outputs a functional predictive feedrate map 460 that is predictive of feedrate. The functional predictive feedrate map 460 is an example of a predictive map 264. The functional predictive feedrate map 460 predicts feedrate at different locations in a worksite. The functional predictive feedrate map 460 may be provided to control zone generator 313, control system 314, and/or presented to an operator 360 or user 366, or both. Control zone generator 313 generates control zones and incorporates those control zones into the functional predictive feedrate map 460 to produce a functional predictive feedrate control zone map 461. The functional predictive feedrate control zone map 461 is an example of a predictive map with control zones 265. In one example, the functional predictive feedrate control zone map 461 can include, as control zones, high feedrate control zones and low feedrate control zones. For example, predictive feedrate values at or exceeding (e.g., above) a threshold value (e.g., threshold feedrate value) may be grouped in into high feedrate zones. Predictive feedrate values at or exceeding (e.g., below) a threshold value (e.g., a threshold feedrate value) may be grouped into low feedrate zones. Thus, in one example, functional predictive feedrate control zone map 461 can include, as control zones, high feedrate control zones and low feedrate control zones.

One or both of functional predictive feedrate map 460 and functional predictive feedrate control zone map 461 may be provided to control system 314, which generates control signals to control one or more of the controllable subsystems 316 based upon the functional predictive feedrate map 460, the functional predictive feedrate control zone map 461, or both. Alternatively, or additionally, of functional predictive feedrate map 460 and functional predictive feedrate control zone map 461 may be provided to an operator 360 or user 366, or both, such as via display or other output on an interface mechanism.

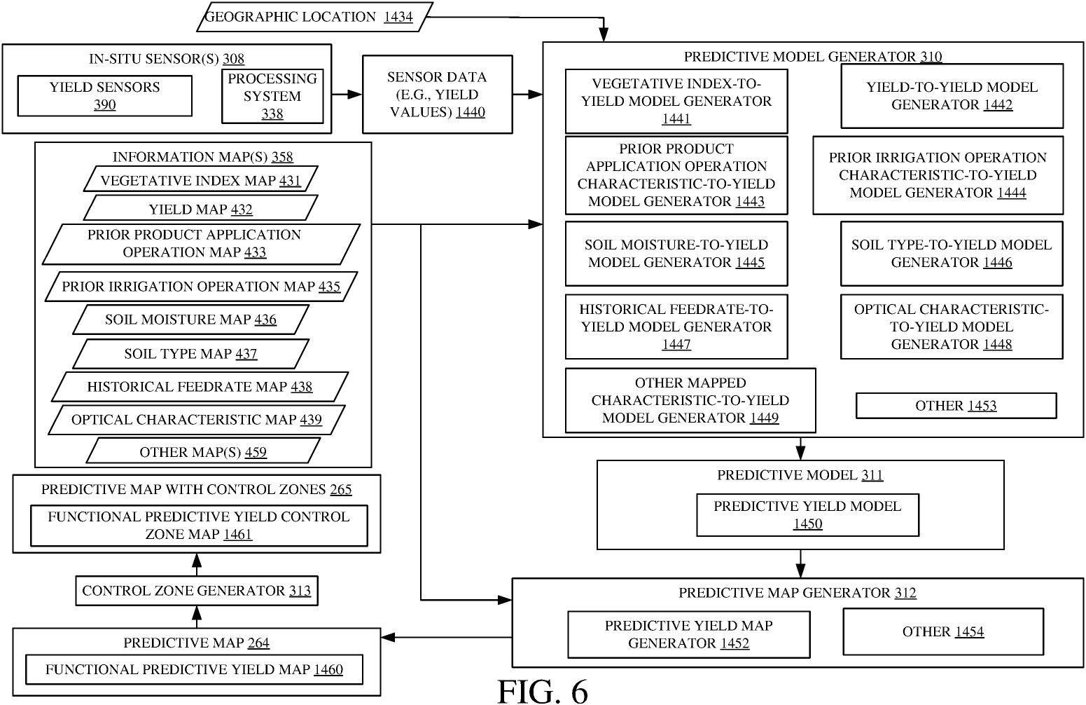

FIG. 6 is a block diagram of a portion of the agricultural cotton harvesting system architecture 300 shown in FIG. 4. Particularly, FIG. 6 shows, among other things, examples of the predictive model generator 310 and the predictive map generator 312 in more detail. FIG. 6 also illustrates information flow among the various components shown. The predictive model generator 310 receives one or more of a vegetative index map 431, a yield map 432, prior product application operation map 433, a prior irrigation operation map 435, a soil moisture map 436, a soil type map 437, a historical feedrate map 438, an optical characteristic map 439, and another type of map 459. Predictive model generator 310 also receives a geographic location 1434, or an indication of a geographic location, from geographic positions sensor 304. In some examples, the geographic location of the cotton harvester 301 and the geographic location of the variable detected by in-situ sensors 308 are not the same, for instance, the location, to which the yield value may be attributed, may be located behind the agricultural harvester (or header) at the time the yield is sensed. For example, the location of the cotton harvester 301 at the time a signal from the in-situ sensor is received may not be the accurate location to which the yield can be attributed. This is because an amount of time elapses between when the cotton harvester makes initial contact with the crop plant and when the yield resulting from the crop plant is sensed. Thus, a transient time between when the crop is encountered by the cotton harvester and when the yield is sensed is taken into account when georeferencing the sensed data. Thus, a combination of the timing of the detection, the position of the respective sensor, the geographic location of the agricultural harvester, the speed and heading of the cotton harvester may be used to derive the corresponding geographic location of the yield value. In either case, geographic location 1434 indicates a geographic location on the worksite to which a respective yield value corresponds.

In-situ sensors 308 illustratively include yield sensors 390, as well as a processing system 338. In some instances, yield sensors 390 may be located on-board cotton harvester 301. In the illustrated example of FIG. 6, processing system 338 processes sensor data generated from yield sensors 390 to generate processed sensor data 1440 indicative of yield values. While the processing system 338 is illustrated as part of in-situ sensors 308 in FIG. 6, in other examples processing system 338 can be separate from but in operable communication with in-situ sensors 308, such as the example shown in FIG. 4.

As shown in FIG. 6, the example predictive model generator 310 includes, as examples of predictive model generators 311, one or more of a vegetative index-to-yield model generator 1441, a yield-to-yield model generator 1442, a prior product application operation characteristic-to-yield model generator 1443, a prior irrigation operation characteristic-to-yield model generator 1444, a soil moisture-to-yield model generator 1445, a soil type-to-yield model generator 1446, a historical feedrate-to-yield model generator 1447, an optical characteristic-to-yield model generator 1448, and an other mapped characteristic-to-yield model generator 1449. In other examples, the predictive model generator 310 may include additional, fewer, or different components than those shown in the example of FIG. 6. Consequently, in some examples, the predictive model generator 310 may include other items 1453 as well, which may include other types of predictive model generators to generate other types of models, such as other types of feedrate models.

Vegetative index-to-yield model generator 1441 identifies a relationship between yield values detected in in-situ sensor data 1440 and vegetative index values from the vegetative index map 431 corresponding to the same locations to which the detected yield values correspond. Based on this relationship established by vegetative index-to-yield model generator 1441, vegetative index-to-yield model generator 1441 generates a predictive yield model. The predictive yield model is used by yield map generator 1452 to predict values of yield (or the sensor values indicative of yield values) at different locations in the worksite based upon the georeferenced vegetative index values contained in the vegetative index map 431 at those different locations in the worksite. Thus, for a given location in the worksite, yield can be predicted at the given location based on the predictive yield model generated by vegetative index-to-yield model generator 1441 and the vegetative index value, from the vegetative index map 431, at that given location.

Yield-to-yield model generator 1442 identifies a relationship between yield values detected in in-situ sensor data 1440 and yield values from the yield map 432 corresponding to the same locations to which the detected yield values correspond. Based on this relationship established by yield-to-yield model generator 1442, yield-to-yield model generator 1442 generates a predictive yield model. The predictive yield model is used by yield map generator 1452 to predict values of yield (or the sensor values indicative of yield values) at different locations in the worksite based upon the georeferenced yield values contained in the yield map 432 at those different locations in the worksite. Thus, for a given location in the worksite, yield can be predicted at the given location based on the predictive yield model generated by yield-to-yield model generator 1442 and the yield value, from the yield map 432, at that given location.

Prior product application operation characteristic-to-yield model generator 1443 identifies a relationship between yield values detected in in-situ sensor data 1440 and prior product application operation characteristic values from the prior product application operation map 433 corresponding to the same locations to which the detected yield values correspond. Based on this relationship established by prior product application operation characteristic-to-yield model generator 1443, prior product application operation characteristic-to-yield model generator 1443 generates a predictive yield model. The predictive yield model is used by yield map generator 1452 to predict values of yield (or the sensor values indicative of yield values) at different locations in the worksite based upon the georeferenced prior product application operation characteristic values contained in the prior product application operation map 433 at those different locations in the worksite. Thus, for a given location in the worksite, yield can be predicted at the given location based on the predictive yield model generated by prior product application operation characteristic-to-yield model generator 1443 and the prior product application operation characteristic value, from the prior product application operation map 433, at that given location.

Prior irrigation operation characteristic-to-yield model generator 1444 identifies a relationship between yield values detected in in-situ sensor data 1440 and prior irrigation operation characteristic values from the prior irrigation operation map 435 corresponding to the same locations to which the detected yield values correspond. Based on this relationship established by prior irrigation operation characteristic-to-yield model generator 1444, prior irrigation operation characteristic-to-yield model generator 1444 generates a predictive yield model. The predictive yield model is used by yield map generator 1452 to predict values of yield (or the sensor values indicative of yield values) at different locations in the worksite based upon the georeferenced prior irrigation operation characteristic values contained in the prior irrigation operation map 435 at those different locations in the worksite. Thus, for a given location in the worksite, yield can be predicted at the given location based on the predictive yield model generated by prior irrigation operation characteristic-to-yield model generator 1444 and the prior irrigation operation characteristic value, from the prior irrigation operation map 435, at that given location.

Soil moisture-to-yield model generator 1445 identifies a relationship between yield values detected in in-situ sensor data 1440 and soil moisture values from the soil moisture map 436 corresponding to the same locations to which the detected yield values correspond. Based on this relationship established by soil moisture-to-yield model generator 1445, soil moisture-to-yield model generator 1445 generates a predictive yield model. The predictive yield model is used by yield map generator 1452 to predict values of yield (or the sensor values indicative of yield values) at different locations in the worksite based upon the georeferenced soil moisture values contained in the soil moisture map 436 at those different locations in the worksite. Thus, for a given location in the worksite, yield can be predicted at the given location based on the predictive yield model generated by soil moisture-to-yield model generator 1445 and the soil moisture value, from the soil moisture map 436, at that given location.

Soil type-to-yield model generator 1446 identifies a relationship between yield values detected in in-situ sensor data 1440 and soil type values from the soil type map 437 corresponding to the same locations to which the detected yield values correspond. Based on this relationship established by soil type-to-yield model generator 1446, soil type-to-yield model generator 1446 generates a predictive yield model. The predictive yield model is used by yield map generator 1452 to predict values of yield (or the sensor values indicative of yield values) at different locations in the worksite based upon the georeferenced soil type values contained in the soil type map 437 at those different locations in the worksite. Thus, for a given location in the worksite, yield can be predicted at the given location based on the predictive yield model generated by soil type-to-yield model generator 1446 and the soil type value, from the soil type map 437, at that given location.

Historical feedrate-to-yield model generator 1447 identifies a relationship between yield values detected in in-situ sensor data 1440 and historical feedrate values from the historical feedrate map 438 corresponding to the same locations to which the detected yield values correspond. Based on this relationship established by historical feedrate-to-yield model generator 1447, historical feedrate-to-yield model generator 1447 generates a predictive yield model. The predictive yield model is used by yield map generator 1452 to predict values of yield (or the sensor values indicative of yield values) at different locations in the worksite based upon the georeferenced historical feedrate values contained in the historical feedrate map 438 at those different locations in the worksite. Thus, for a given location in the worksite, yield can be predicted at the given location based on the predictive yield model generated by historical feedrate-to-yield model generator 1447 and the historical feedrate value, from the historical feedrate map 438, at that given location.

Optical characteristic-to-yield model generator 1448 identifies a relationship between yield values detected in in-situ sensor data 1440 and optical characteristic values from the optical characteristic map 439 corresponding to the same locations to which the detected yield values correspond. Based on this relationship established by optical characteristic-to-yield model generator 1448, optical characteristic-to-yield model generator 1448 generates a predictive yield model. The predictive yield model is used by yield map generator 1452 to predict values of yield (or the sensor values indicative of yield values) at different locations in the worksite based upon the georeferenced optical characteristic values contained in the optical characteristic map 438 at those different locations in the worksite. Thus, for a given location in the worksite, yield can be predicted at the given location based on the predictive yield model generated by optical characteristic-to-yield model generator 1448 and the optical characteristic value, from the optical characteristic map 439, at that given location.

Other mapped characteristic-to-yield model generator 1449 identifies a relationship between yield values detected in in-situ sensor data 1440 and other mapped characteristic values from an other map 459 corresponding to the same locations to which the detected yield values correspond. Based on this relationship established by other mapped characteristic-to-yield model generator 1449, other mapped characteristic-to-yield model generator 1449 generates a predictive yield model. The predictive yield model is used by yield map generator 1452 to predict values of yield (or the sensor values indicative of yield values) at different locations in the worksite based upon the georeferenced other characteristic values contained in the other map 459 at those different locations in the worksite. Thus, for a given location in the worksite, yield can be predicted at the given location based on the predictive yield model generated by other mapped characteristic-to-yield model generator 1449 and the other characteristic value, from the other map 459, at that given location.

In light of the above, the predictive model generator 310 is operable to produce a plurality of predictive yield models, such as one or more of the predictive yield models generated by model generators 1441, 1442, 1443, 1444, 1445, 1446, 1447, 1448, 1449, and 1453. In another example, two or more of the predictive models described above may be combined into a single predictive yield model, such as a predictive yield model that predicts yield based upon two or more of vegetative index values, yield values, prior product application operation characteristic values, prior irrigation operation characteristic values, soil moisture values, soil type values, historical feedrate values, optical characteristic values, and the other characteristic values at different locations in the field. Any of these yield models, or combinations thereof, are represented collectively by predictive yield model 1450 in FIG. 6. Predictive yield model 1450 is an example of a predictive model 311.

The predictive yield model 1450 is provided to predictive map generator 312. In the example of FIG. 6, predictive map generator 312 includes a yield map generator 1452. In other examples, predictive map generator 312 may include additional or different map generators. Thus, in some examples, predictive map generator 312 may include other items 1454 which may include other types of map generators to generate other types of maps.

Yield map generator 1452 receives one or more of the vegetative index map 431, the yield map 432, the prior product application operation map 433, the prior irrigation operation map 435, the soil moisture map 436, the soil type map 437, the historical feedrate map 438, the optical characteristic map 439, and another type of map 459, along with the predictive yield model 1450 which predicts values of yield based upon one or more of vegetative index values, yield values, prior product application operation characteristic values, prior irrigation operation characteristic values, soil moisture values, soil type values, historical feedrate values, optical characteristic values, and the other mapped characteristic values and generates a predictive yield map that predicts yield at different locations in the worksite.

Predictive map generator 312 outputs a functional predictive yield map 1460 that is predictive of yield. The functional predictive yield map 1460 is an example of a predictive map 264. The functional predictive yield map 1460 predicts yield at different locations in a worksite. The functional predictive yield map 1460 may be provided to control zone generator 313, control system 314, and/or presented to an operator 360 or user 366, or both. Control zone generator 313 generates control zones and incorporates those control zones into the functional predictive yield map 1460 to produce a functional predictive yield control zone map 1461. The functional predictive yield control zone map 1461 is an example of a predictive map with control zones 265. In one example, the functional predictive yield control zone map 1461 can include, as control zones, high yield control zones and low yield control zones. For example, predictive yield values at or exceeding (e.g., above) a threshold value (e.g., threshold yield value) may be grouped in into high yield zones. Predictive yield values at or exceeding (e.g., below) a threshold value (e.g., a threshold yield value) may be grouped into low yield zones. Thus, in one example, functional predictive yield control zone map 1461 can include, as control zones, high yield control zones and low yield control zones.

One or both of functional predictive yield map 1460 and functional predictive yield control zone map 1461 may be provided to control system 314, which generates control signals to control one or more of the controllable subsystems 316 based upon the functional predictive yield map 1460, the functional predictive yield control zone map 1461, or both. Alternatively, or additionally, of functional predictive yield map 1460 and functional predictive yield control zone map 1461 may be provided to an operator 360 or user 366, or both, such as via display or other output on an interface mechanism.

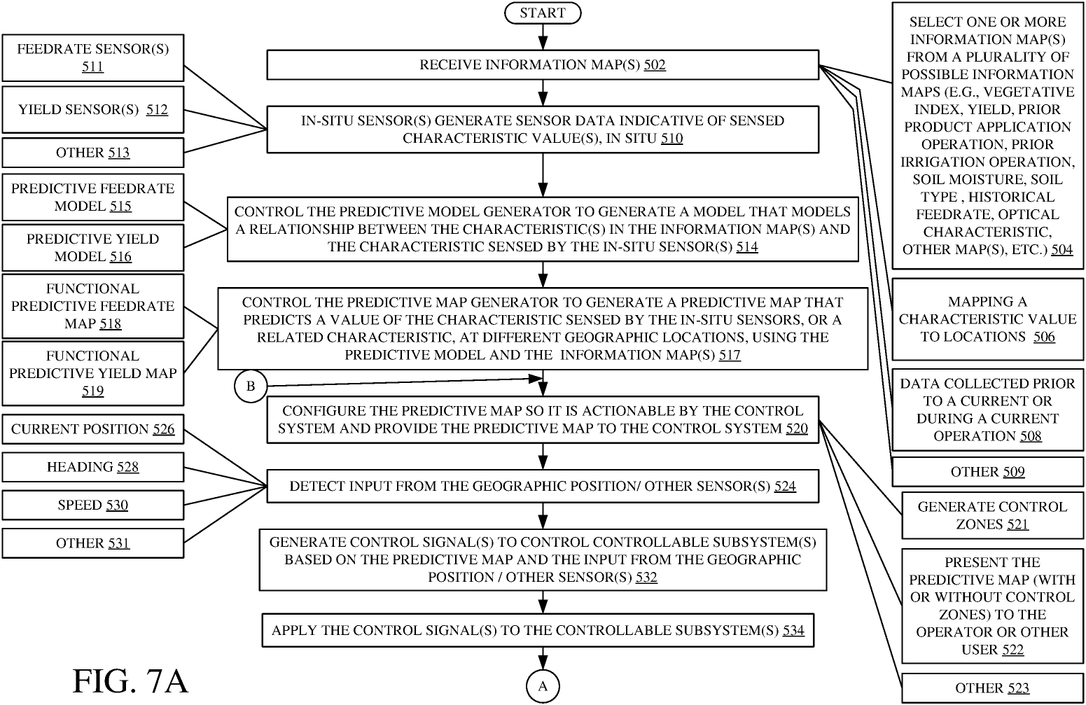

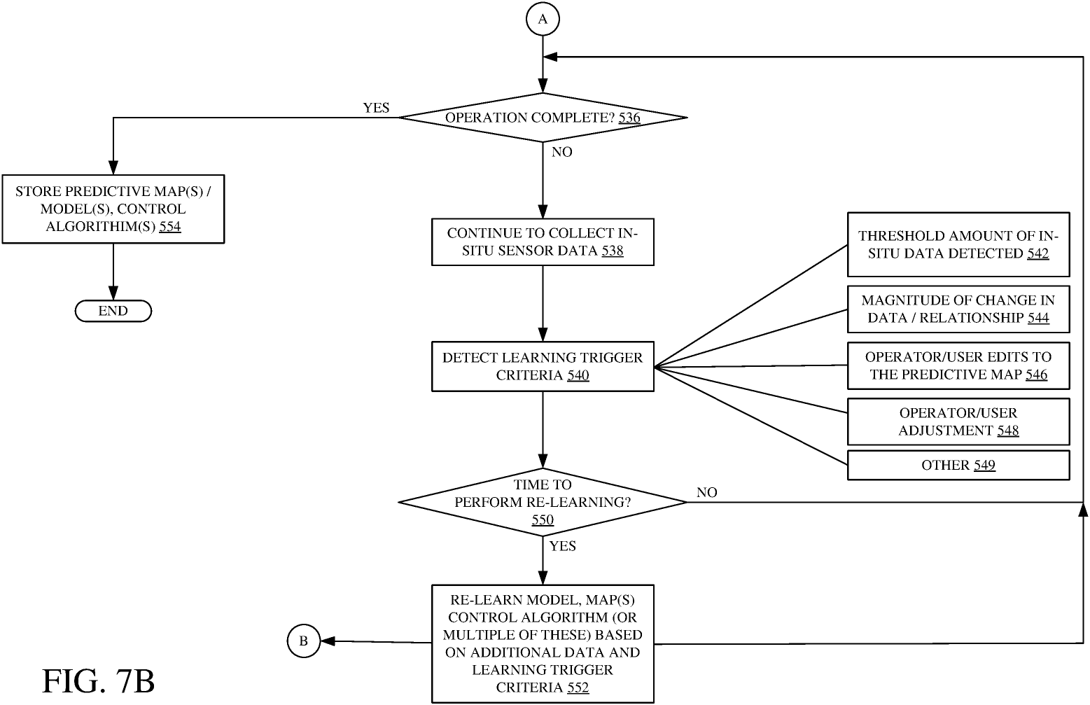

FIGS. 7A-7B (collectively referred to herein as FIG. 7) show a flow diagram illustrating one example of the operation of agricultural cotton harvesting system architecture 300 in generating a predictive model and a predictive map.

At block 502, cotton harvesting system 300 receives one or more information maps 358. Examples of information maps 358 or receiving information maps 358 are discussed with respect to blocks 504, 506, 508, and 509. As discussed above, information maps 358 map values of a variable, corresponding to a characteristic, to different locations, as indicated at block 506. As indicated at block 504, receiving the information maps 358 may involve selecting one or more of a plurality of possible information maps 358 that are available. For instance, one information map 358 may be a vegetative index map, such as vegetative index map 431. Another information map 358 may be a yield map, such as yield map 432. Another information map 358 may be a prior product application operation map, such as prior spraying operation map 433. Another information map may be a prior irrigation operation map, such as prior irrigation operation map 435. Another information map may be a soil moisture map, such as soil moisture map 436. Another information map may be a soil type map, such as soil type map 437. Another information map may be a historical feedrate map, such as historical feedrate map 438. Another information map may be an optical characteristic map, such as optical characteristic map 439. An information map 358 can be various other maps, such as other maps 459. The process by which one or more information maps 358 are selected can be manual, semi-automated, or automated. The information maps 358 can be based on data collected prior to a current operation. For instance, the data may be collected based on aerial images taken during a previous year, or earlier in the current season, or at other times. The data may be based on data detected in ways other than using aerial images. For instance, the data may be collected during a previous operation on the worksite, such as an operation during a previous year, or a previous operation earlier in the current season, or at other times. The machines performing those previous operations may be outfitted with one or more sensors that generate sensor data indicative of one or more characteristics. For example, the product application operation characteristics (e.g., yield, biomass, plant health, plant size, plant stress, etc.) sensed during a product application operation performed at the worksite earlier in the same year (or same season) may be used as data to generate the information maps 358 (e.g., a prior product application operation map). In another example, the irrigation characteristics (e.g., irrigation application rates, irrigation application locations, etc.) sensed during an irrigation operation performed at the worksite earlier in the same year (or same season) may be used as data to generate the information maps (e.g., a prior irrigation operation map). In another example, the historical feedrate values sensed during a harvesting operation at the worksite in a previous year may be used as data to generate the information maps (e.g., a historical feedrate map). In other examples, and as described above, the information maps 358 may be predictive maps having predictive values, such as a predictive yield map having predictive yield values. In some examples, the predictive yield values could be based on vegetative index values. The predictive information map 358 can be generated by predictive map generator 312 based on a model generated by predictive model generator 310. The data for the information maps 358 can be obtained by cotton harvesting system 300 using communication system 306 and stored in data store 302. The data for the information maps 358 can be obtained by cotton harvesting system 300 using communication system 306 in other ways as well, and this is indicated by block 509 in the flow diagram of FIG. 7.

At block 510, as cotton harvester 301 is operating, in-situ sensors 308 generate sensor data (e.g., signals, images, etc.) indicative of one or more in-situ data values indicative of a characteristic. For example, feedrate sensors 380 generate sensor data indicative of one or more in-situ data values indicative of feedrate as indicated by block 511. In another example, yield sensors 390 generate sensor signals, or other sensor data, indicative of one or more in-situ data value indicative of yield as indicated by block 512. In some examples, data from in-situ sensors 308 is georeferenced using a combination of timing of the detection, the position of the in-situ sensor, the position of the cotton harvester 301 at the time the variable is detected, heading of the cotton harvester 301, and speed of the cotton harvester 301, as well as various other data.

In one example, predictive model generator 310 controls one or more of the vegetative index-to-feedrate model generator 441, the yield-to-feedrate model generator 442, the prior product application operation characteristic-to-feedrate model generator 443, the prior irrigation operation characteristic-to-feedrate model generator 444, the soil moisture-to-feedrate model generator 445, the soil type-to-feedrate model generator 446, the historical feedrate-to-feedrate model generator 447, the optical characteristic-to-feedrate model generator 448, and the other mapped characteristic-to-feedrate model generator 449 to generate a model that models the relationship between the mapped values, such as one or more of the vegetative index values, the yield values, the prior product application operation characteristic values, the prior irrigation operation characteristic values, the soil moisture values, the soil type values, the historical feedrate values, the optical characteristic values, and the other characteristic values contained in the respective information map and the corresponding in-situ values sensed by the in-situ sensors 308 as indicated by block 514. Predictive model generator 310 generates a predictive feedrate model 450 as indicated by block 515.

In another example, predictive model generator 310 controls one or more of the vegetative index-to-yield model generator 1441, the yield-to-yield model generator 1442, the prior product application operation characteristic-to-yield model generator 1443, the prior irrigation operation characteristic-to-yield model generator 1444, the soil moisture-to-yield model generator 1445, the soil type-to-yield model generator 1446, the historical feedrate-to-yield model generator 1447, the optical characteristic-to-yield model generator 1448, and the other mapped characteristic-to-yield model generator 1449 to generate a model that models the relationship between the mapped values, such as one or more of the vegetative index values, the yield values, the prior product application operation characteristic values, the prior irrigation operation characteristic values, the soil moisture values, the soil type values, the historical feedrate values, the optical characteristic values, and the other characteristic values contained in the respective information map and the corresponding in-situ values sensed by the in-situ sensors 308 as indicated by block 514. Predictive model generator 310 generates a predictive yield model 1450 as indicated by block 516.

At block 517, the relationship or model generated by predictive model generator 310 is provided to predictive map generator 312. In one example, predictive map generator 312 controls a predictive feedrate map generator 452 to generate a functional predictive feedrate map 460 that predicts feedrate values (or sensor values indictive of feedrate) at different geographic locations, in the worksite (e.g., field) at which cotton harvester 301 is operating, using the predictive feedrate model 450 and one or more of the information maps, such as one or more of vegetative index map 431, yield map 432, prior product application operation map 433, prior irrigation operation map 435, soil moisture map 436, soil type map 437, historical feedrate map 438, optical characteristic map 439, and another type of map 459 as indicated by block 518. In another example, predictive map generator 312 controls a predictive yield map generator 1452 to generate a functional predictive yield map 1460 that predicts yield values (or sensor values indictive of yield) at different geographic locations, in the worksite (e.g., field) at which cotton harvester 301 is operating, using the predictive yield model 1450 and one or more of the information maps, such as one or more of vegetative index map 431, yield map 432, prior product application operation map 433, prior irrigation operation map 435, soil moisture map 436, soil type map 437, historical feedrate map 438, optical characteristic map 439, and another type of map 459 as indicated by block 519.

It should be noted that, in some examples, the functional predictive feedrate map 460 may include two or more different map layers. Each map layer may represent a different data type, for instance, a functional predictive feedrate map 460 that provides two or more of a map layer that provides predictive feedrate based on vegetative index values from vegetative index map 431, a map layer that provides predictive feedrate based on yield values from yield map 432, a map layer that provides predictive feedrate based on prior product application operation characteristic values from prior product application operation map 433, a map layer that provides predictive feedrate based on prior irrigation operation characteristic values from prior irrigation operation map 435, a map layer that provides predictive feedrate based on soil moisture values from soil moisture map 436, a map layer that provides predictive feedrate based on soil type values from soil type map 437, a map layer that provides predictive feedrate based on historical feedrate values from historical feedrate map 438, a map layer that provides predictive feedrate based on optical characteristic values from optical characteristic map 439, and a map layer that provides predictive feedrate based on other mapped characteristic values from an other map 459. Alternatively, or additionally, functional predictive feedrate map 460 may include one or more map layers that provide predictive feedrate based on two or more of vegetative index values from vegetative index map 431, yield values from yield map 432, prior product application operation characteristic values from prior product application operation map 433, prior irrigation operation characteristic values from prior irrigation operation map 435, soil moisture values from soil moisture map 436, soil type values from soil type map 437, historical feedrate values from historical feedrate map 438, optical characteristic values from optical characteristic map 439, and other mapped characteristic values from an other map 459.

It should be noted that, in some examples, the functional predictive yield map 1460 may include two or more different map layers. Each map layer may represent a different data type, for instance, a functional predictive yield map 1460 that provides two or more of a map layer that provides predictive yield based on vegetative index values from vegetative index map 431, a map layer that provides predictive yield based on yield values from yield map 432, a map layer that provides predictive yield based on prior product application operation characteristic values from prior product application operation map 433, a map layer that provides predictive yield based on prior irrigation operation characteristic values from prior irrigation operation map 435, a map layer that provides predictive yield based on soil moisture values from soil moisture map 436, a map layer that provides predictive yield based on soil type values from soil type map 437, a map layer that provides predictive yield based on historical feedrate values from historical feedrate map 438, a map layer that provides predictive yield based on optical characteristic values from optical characteristic map 439, and a map layer that provides predictive yield based on other mapped characteristic values from an other map 459. Alternatively, or additionally, functional predictive yield map 1460 may include one or more map layers that provide predictive yield based on two or more of vegetative index values from vegetative index map 431, yield values from yield map 432, prior product application operation characteristic values from prior product application operation map 433, prior irrigation operation characteristic values from prior irrigation operation map 435, soil moisture values from soil moisture map 436, soil type values from soil type map 437, historical feedrate values from historical feedrate map 438, optical characteristic values from optical characteristic map 439, and other mapped characteristic values from an other map 459.

At block 520, predictive map generator 312 configures the functional predictive feedrate map 460 or the functional predictive yield map 1460, or both, so that the functional predictive feedrate map 460 or the functional predictive yield map 1460, or both, is actionable (or consumable) by control system 314. Predictive map generator 312 can provide the functional predictive feedrate map 460 or the functional predictive yield map 1460, or both, to the control system 314 or to control zone generator 313, or both. Some examples of the different ways in which the functional predictive feedrate map 460 or the functional predictive yield map 1460, or both, can be configured or output are described with respect to blocks 520, 521, 522, and 523. For instance, predictive map generator 312 configures functional predictive feedrate map 460 so that functional predictive feedrate map 460 includes values that can be read by control system 314 and used as the basis for generating control signals for one or more of the different controllable subsystems 316 of cotton harvester 301, as indicated by block 520. In another example, predictive map generator 312 configures functional predictive yield map 1460 so that functional predictive yield map 1460 includes values that can be read by control system 314 and used as the basis for generating control signals for one or more of the different controllable subsystems 316 of cotton harvester 301, as indicated by block 520.

At block 521, control zone generator 313 can divide the functional predictive feedrate map 460 into control zones based on the values on the functional predictive feedrate map 460 to generate functional predictive feedrate control zone map 461. In another example, at block 521, control zone generator 313 can divide the functional predictive yield map 1460 into control zones based on the values on the functional predictive yield map 1460 to generate functional predictive yield control zone map 1461. Contiguously-geolocated values that are within a threshold value of one another can be grouped into a control zone. The threshold value can be a default threshold value, or the threshold value can be set based on an operator input or user input, based on an input from an automated system, or based on other criteria. A size of the zones may be based on a responsiveness of the control system 314, the controllable subsystems 316, based on wear considerations, or on other criteria. In one example, the functional predictive feedrate control zone map 461 can include, as control zones, high feedrate control zones and low feedrate control zones. In one example, the functional predictive yield control zone map 1461 can include, as control zone, high yield control zones and low yield control zones.

At block 522, predictive map generator 312 configures functional predictive feedrate map 460 or functional predictive yield map 1460, or both, for presentation to an operator or other user. At block 522, control zone generator 313 can configure functional predictive feedrate control zone map 461 or functional predictive yield control zone map 1461, or both, for presentation to an operator or other user.

When presented to an operator or other user, the presentation of the functional predictive feedrate map 460 or of functional predictive feedrate control zone map 461 or both may contain one or more of the predictive values on the functional predictive feedrate map 460 correlated to geographic location, the control zones of functional predictive feedrate control zone map 461 correlated to geographic location, and settings values or control parameters that are used based on the predicted values on predictive map 460 or control zones on predictive control zone map 461 correlated to geographic location. The presentation can, in another example, include more abstracted information or more detailed information. The presentation can also include a confidence level that indicates an accuracy with which the predictive values on predictive map 460 or the control zones on predictive control zone map 461 conform to measured values that may be measured by sensors on cotton harvester 301 as cotton harvester 301 operates at the worksite. Further where information is presented to more than one location, an authentication and authorization system can be provided to implement authentication and authorization processes. For instance, there may be a hierarchy of individuals that are authorized to view and change maps and other presented information. By way of example, an on-board display device may show the maps in near real time locally on the machine, or the maps may also be generated at one or more remote locations, or both. In some examples, each physical display device at each location may be associated with a person or a user permission level. The user permission level may be used to determine which display elements are visible on the physical display device and which values the corresponding person may change. As an example, a local operator of cotton harvester 301 may be unable to see the information corresponding to the predictive map 460 or predictive control zone map 461, or both, or make any changes to machine operation. A supervisor, such as a supervisor at a remote location, however, may be able to see the predictive map 460 or predictive control zone map 461, or both, on the display but be prevented from making any changes. A manager, who may be at a separate remote location, may be able to see all of the elements on predictive map 460 or the predictive control zone map 461, or both, and also be able to change the predictive map 460 or the predictive control zone map 461, or both. In some instances, the predictive map 460 or the predictive control zone map 461, or both, accessible and changeable by a manager located remotely may be used in machine control. This is one example of an authorization hierarchy that may be implemented. The predictive map 460 or predictive control zone map 461 or both can be configured in other ways as well, as indicated by block 523.

When presented to an operator or other user, the presentation of the functional predictive yield map 1460 or of functional predictive yield control zone map 1461 or both may contain one or more of the predictive values on the functional predictive yield map 1460 correlated to geographic location, the control zones of functional predictive yield control zone map 1461 correlated to geographic location, and settings values or control parameters that are used based on the predicted values on predictive map 1460 or control zones on predictive control zone map 1461 correlated to geographic location. The presentation can, in another example, include more abstracted information or more detailed information. The presentation can also include a confidence level that indicates an accuracy with which the predictive values on predictive map 1460 or the control zones on predictive control zone map 1461 conform to measured values that may be measured by sensors on cotton harvester 301 as cotton harvester 301 operates at the worksite. Further where information is presented to more than one location, an authentication and authorization system can be provided to implement authentication and authorization processes. For instance, there may be a hierarchy of individuals that are authorized to view and change maps and other presented information. By way of example, an on-board display device may show the maps in near real time locally on the machine, or the maps may also be generated at one or more remote locations, or both. In some examples, each physical display device at each location may be associated with a person or a user permission level. The user permission level may be used to determine which display elements are visible on the physical display device and which values the corresponding person may change. As an example, a local operator of cotton harvester 301 may be unable to see the information corresponding to the predictive map 1460 or predictive control zone map 1461, or both, or make any changes to machine operation. A supervisor, such as a supervisor at a remote location, however, may be able to see the predictive map 1460 or predictive control zone map 1461, or both, on the display but be prevented from making any changes. A manager, who may be at a separate remote location, may be able to see all of the elements on predictive map 1460 or the predictive control zone map 1461, or both, and also be able to change the predictive map 1460 or the predictive control zone map 1461, or both. In some instances, the predictive map 1460 or the predictive control zone map 1461, or both, accessible and changeable by a manager located remotely may be used in machine control. This is one example of an authorization hierarchy that may be implemented. The predictive map 1460 or predictive control zone map 1461 or both can be configured in other ways as well, as indicated by block 523.

At block 524, input from geographic position sensor 304 and other in-situ sensors 308 are received by the control system 314. Particularly, at block 526, control system 314 detects an input from the geographic position sensor 304 identifying a geographic location of cotton harvester 301. Block 528 represents receipt by the control system 314 of sensor inputs indicative of trajectory or heading of cotton harvester 301, and block 530 represents receipt by the control system 314 of a speed of cotton harvester 301. Block 531 represents receipt by the control system 314 of other information from various in-situ sensors 308.

In one example, at block 532, control system 314 generates control signals to control the controllable subsystems 316 based on the functional predictive feedrate map 460 or the functional predictive feedrate control zone map 461 or both and the input from the geographic position sensor 304 and any other in-situ sensors 308, such as heading and/or speed inputs from heading/speed sensors 325. At block 534, control system 314 applies the control signals to the controllable subsystems 316. It will be appreciated that the particular control signals that are generated, and the particular controllable subsystems 316 that are controlled, may vary based upon one or more different things. For example, the control signals that are generated and the controllable subsystems 316 that are controlled may be based on the type of functional predictive feedrate map 460 or functional predictive feedrate control zone map 461 or both that is being used. Similarly, the control signals that are generated and the controllable subsystems 316 that are controlled and the timing of the control signals can be based on various latencies of cotton harvester 301 and the responsiveness of the controllable subsystems 316.

By way of example, propulsion controller 331 can generate control signals to control propulsion subsystem 350 to control a speed at which cotton harvester 301 traverses the worksite based on the functional predictive feedrate map 460 or functional predictive feedrate control zone map 461, or both. Path planning controller 332 can generate control signals to control steering subsystem 352 to control a travel path (or heading) of cotton harvester 301 based on the functional predictive feedrate map 460 or functional predictive feedrate control zone map 461, or both. In one example, the functional predictive feedrate control zone map 461 may include high feedrate zones and low feedrate zones. Path planning controller 332 can generate a route for cotton harvester 301 based on the high feedrate control zones and the low feedrate control zones. For example, path planning controller 332 can generate a route for cotton harvester 301 that reduces the transitions from low feedrate control zones to high feedrate control zones or that increases the transitions from high feedrate control zones to low feedrate control zones, or both.

These are merely some examples. Control system 314, and its corresponding controllers, can generate a variety of different control signals to control a variety of different controllable subsystems 316 based on functional predictive feedrate map 460 or functional predictive feedrate control zone map 461, or both.

In another example, at block 532, control system 314 generates control signals to control the controllable subsystems 316 based on the functional predictive yield map 1460 or the functional predictive yield control zone map 1461 or both and the input from the geographic position sensor 304 and any other in-situ sensors 308, such as heading and/or speed inputs from heading/speed sensors 325. At block 534, control system 314 applies the control signals to the controllable subsystems 316. It will be appreciated that the particular control signals that are generated, and the particular controllable subsystems 316 that are controlled, may vary based upon one or more different things. For example, the control signals that are generated and the controllable subsystems 316 that are controlled may be based on the type of functional predictive yield map 1460 or functional predictive yield control zone map 1461 or both that is being used. Similarly, the control signals that are generated and the controllable subsystems 316 that are controlled and the timing of the control signals can be based on various latencies of cotton harvester 301 and the responsiveness of the controllable subsystems 316.

By way of example, propulsion controller 331 can generate control signals to control propulsion subsystem 350 to control a speed at which cotton harvester 301 traverses the worksite based on the functional predictive yield map 1460 or functional predictive yield control zone map 1461, or both. Path planning controller 332 can generate control signals to control steering subsystem 352 to control a travel path (or heading) of cotton harvester 301 based on the functional predictive yield map 1460 or functional predictive yield control zone map 1461, or both. In one example, the functional predictive yield control zone map 1461 may include high yield zones and low yield zones. Path planning controller 332 can generate a route for cotton harvester 301 based on the high yield control zones and the low yield control zones. For example, path planning controller 332 can generate a route for cotton harvester 301 that reduces the transitions from low yield control zones to high yield control zones or that increases the transitions from high yield control zones to low yield control zones, or both .

These are merely some examples. Control system 314, and its corresponding controllers, can generate a variety of different control signals to control a variety of different controllable subsystems 316 based on functional predictive yield map 1460 or functional predictive yield control zone map 1461, or both.

At block 536, a determination is made as to whether the operation has been completed. If the operation is not completed, the processing advances to block 538 where in-situ sensor data from geographic position sensor 304 and in-situ sensors 308 (and perhaps other sensors) continue to be read.

In some examples, at block 540, cotton harvesting system 300 can also detect learning trigger criteria to perform machine learning on one or more of the functional predictive feedrate map 460, functional predictive feedrate control zone map 461, predictive feedrate model 450, the zones generated by control zone generator 313, one or more control algorithms implemented by the controllers in the control system 314, and other triggered learning. In some examples, at block 540, cotton harvesting system 300 can also detect learning trigger criteria to perform machine learning on one or more of the functional predictive yield map 1460, functional predictive yield control zone map 1461, predictive yield model 1450, the zones generated by control zone generator 313, one or more control algorithms implemented by the controllers in the control system 314, and other triggered learning.

The learning trigger criteria can include any of a wide variety of different criteria. Some examples of detecting trigger criteria are discussed with respect to blocks 542, 544, 546, 548, and 549. For instance, in some examples, triggered learning can involve recreation of a relationship used to generate a predictive model when a threshold amount of in-situ sensor data are obtained from in-situ sensors 308. In such examples, receipt of an amount of in-situ sensor data from the in-situ sensors 308 that exceeds a threshold triggers or causes the predictive model generator 310 to generate a new predictive model that is used by predictive map generator 312. Thus, as cotton harvester 301 continues an operation, receipt of the threshold amount of in-situ sensor data from the in-situ sensors 308 triggers the creation of a new relationship represented by a new (e.g., updated) predictive feedrate model 450 or a new (e.g., updated) predictive yield model 1450, or both, generated by predictive model generator 310. Further, a new (e.g., updated) functional predictive feedrate map 460, a new (e.g., updated) functional predictive feedrate control zone map 461, or both, can be generated using the new predictive feedrate model 450. Further, a new (e.g., updated) functional predictive yield map 1460, a new (e.g., updated) functional predictive yield control zone map 1461, or both, can be generated using the new predictive yield model 1450. Block 542 represents detecting a threshold amount of in-situ sensor data used to trigger creation of a new predictive model.

In other examples, the learning trigger criteria may be based on how much the in-situ sensor data from the in-situ sensors 308 are changing, such as over time or compared to previous values. For example, if variations within the in-situ sensor data (or the relationship between the in-situ sensor data and the information in the one or more information maps 358) are within a selected range or is less than a defined amount, or below a threshold value, then a new predictive model is not generated by the predictive model generator 310. As a result, the predictive map generator 312 does not generate a new functional predictive feedrate map 460 or a new functional predictive feedrate control zone map 461, or both, nor does predictive map generator generate a new functional predictive yield map 1460 or a new functional predictive yield control zone map 1461. However, in one example, if variations within the in-situ sensor data are outside of the selected range, are greater than the defined amount, or are above the threshold value, for example, then the predictive model generator 310 generates a new predictive model 450 using all or a portion of the newly received in-situ sensor data that the predictive map generator 312 uses to generate a new predictive map 460 which can be provided to control zone generator 313 for the creation of a new predictive control zone map 461. In another example, if variations within the in-situ sensor data are outside of the selected range, are greater than the defined amount, or are above the threshold value, for example, then the predictive model generator 310 generates a new predictive model 1450 using all or a portion of the newly received in-situ sensor data that the predictive map generator 312 uses to generate a new predictive map 1460 which can be provided to control zone generator 313 for the creation of a new predictive control zone map 1461. At block 544, variations in the in-situ sensor data, such as a magnitude of an amount by which the data exceeds the selected range or a magnitude of the variation of the relationship between the in-situ sensor data and the information in the one or more information maps, can be used as a trigger to cause generation of one or more of a new predictive model (e.g., 450 or 1450, or both), a new predictive map (e.g., 460 or 1460, or both), and a new predictive control zone map (e.g., 461 or 1461, or both). Keeping with the examples described above, the threshold, the range, and the defined amount can be set to default values; set by an operator or user interaction through a user interface; set by an automated system; or set in other ways.

Other learning trigger criteria can also be used, as indicated by block 549. For instance, if predictive model generator 310 switches to a different information map (different from the originally selected information map), then switching to the different information map may trigger re-learning by predictive model generator 310, predictive map generator 312, control zone generator 313, control system 314, or other items. In another example, transitioning of cotton harvester to a different area of the field, such as a different topography area, a different control zone, an area with a different crop genotype, etc., may be used as learning trigger criteria as well.

In some instances, operator 360 or user 366 can also edit the functional predictive feedrate map 460 or functional predictive feedrate control zone map 461 or both. The edits can change a value on the functional predictive feedrate map 460, change a size, shape, position, or existence of a control zone on functional predictive feedrate control zone map 461, or both. In some instances, operator 360 or user 366 can also edit the functional predictive yield map 1460 or functional predictive yield control zone map 1461 or both. The edits can change a value on the functional predictive yield map 1460, change a size, shape, position, or existence of a control zone on functional predictive yield control zone map 1461, or both. Block 546 shows that edited information can be used as learning trigger criteria.

In some instances, it may also be that operator 360 or user 366 observes that automated control of a controllable subsystem 316, is not what the operator or user desires. In such instances, the operator 360 or user 366 may provide a manual adjustment to the controllable subsystem 316 reflecting that the operator 360 or user 366 desires the controllable subsystem 316 to operate in a different way than is being commanded by control system 314. Thus, manual alteration of a setting by the operator 360 or user 366 can cause one or more of predictive model generator 310 to relearn (e.g., update) a model (e.g., 450 or 1450, or both), predictive map generator 312 to regenerate (e.g., update) a functional predictive (e.g., 460 or 1460, or both), control zone generator 313 to regenerate (e.g., update) one or more control zones on functional predictive control zone map (e.g., 461 or 1461, or both), and control system 314 to relearn (e.g., update) a control algorithm or to perform machine learning on one or more of the controller components 329 through 337 in control system 314 based upon the adjustment by the operator 360 or user 366, as shown in block 548. Block 549 represents the use of other triggered learning criteria.

In other examples, relearning may be performed periodically or intermittently based, for example, upon a selected time interval such as a discrete time interval or a variable time interval, as indicated by block 550.

If relearning is triggered, whether based upon learning trigger criteria or based upon passage of a time interval, as indicated by block 550, then one or more of the predictive model generator 310, predictive map generator 312, control zone generator 313, and control system 314 performs machine learning to generate a new (e.g., updated) predictive model, a new (e.g., updated) predictive map, a new (e.g., updated) control zone, and a new (e.g., updated) control algorithm, respectively, based upon the learning trigger criteria. The new predictive model, the new predictive map, the new control zone, and the new control algorithm are generated using any additional data that has been collected since the last learning operation was performed. Performing relearning is indicated by block 552.

If the operation has not been completed, operation moves from block 552 to block 528 such that operation of the cotton harvester 301 can be controlled based on the new predictive map, a new control zone, or a new control algorithm.

If the operation has been completed, operation moves from block 552 to block 554 where, in one example, one or more of the functional predictive map (e.g., 460 or 1460, or both), functional predictive control zone map (e.g., 461 or 1461, or both), the predictive model (e.g., 450 or 1450, or both) generated by predictive model generator 310, the control algorithm, as well as various other data are stored. The predictive map, predictive control zone map, predictive model, and the control algorithm may be stored locally on data store 302 or sent to a remote system using communication system 306 for later use, or both.

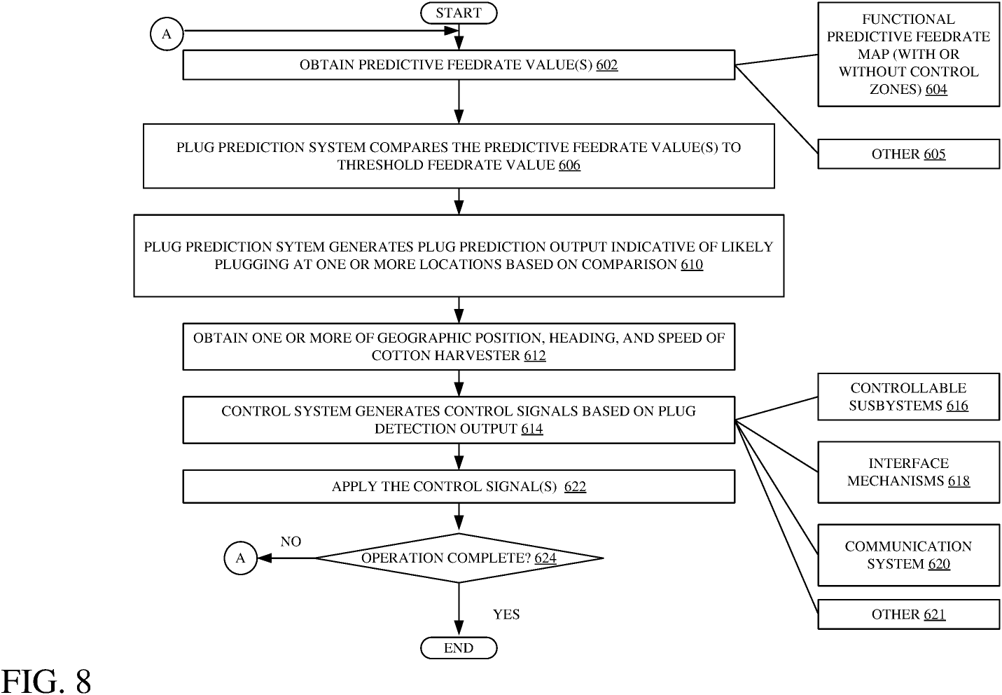

FIG. 8 shows a flow diagram illustrating one example of the operation of agricultural cotton harvesting system architecture 300 in predicting likely plugging of the cotton harvester 301.

At block 602, plug prediction system 340 obtains a predictive feedrate values corresponding to geographic locations at the worksite at which cotton harvester 301 is operating. As indicated by block 604, the predictive feedrate values can be provided by a map, such as functional predictive feedrate map 460 or functional predictive feedrate control zone map 461, or both. The predictive feedrate values can be provided in other ways as well, as indicated by block 605.

At block 606, plug prediction system 340 compares predictive feedrate values to a threshold feedrate value.

At block 610, plug prediction system generates a plug prediction output indicative of likely plugging at one or more locations at the worksite based on the comparison of the predictive feedrate values at each of those one or more locations to the threshold feedrate value. For instance, where the predictive feedrate value for a given location exceeds (e.g., is less than), such as by a threshold amount (e.g., 10%), the threshold feedrate value, plug prediction system can determine that plugging is likely to occur at that given location and can generate a plug prediction output indicative of the likely plugging at that location.

In some examples, agricultural cotton harvesting system 300 can integrate the predicted plugging locations into a map, such as a functional predictive map 264 or functional predictive control zone map 265, or both. In other examples, the predicted plugging locations can be integrated into another type of map, or into its own map or map layer (e.g., a predictive plugging map or predictive plugging map layer).

At block 612, cotton harvesting system 300 obtains one or more of a current geographic position, current heading, and current speed of cotton harvester 301. In some examples, the geographic position, heading, and speed are obtained from in-situ sensors 308, such as geographic position sensor 304 and heading/speed sensors 325.

At block 614, control system 314 generates one or more control signals based on the prediction of likely plugging as indicated by the plug prediction output provided by plug prediction system 340, and, in some examples, based on the geographic position, heading, and speed of cotton harvester 301. As indicated by block 616, control system 314 may generate control signals to control a controllable subsystem 316. For example, propulsion controller 331 can generate control signals to control propulsion subsystem 350 to control a travel speed of cotton harvester 301, such as to change a travel speed (e.g., to decrease the travel speed) at the location where plugging is likely to occur. Path planning controller 332 can generate control signals to control steering subsystem 352 to control a travel path of cotton harvester 301. Various other controllers can generate various other control signals to control various other controllable subsystems 316. As indicated by block 618, interface controller 330 can generate control signals to control one or more interface mechanisms (e.g., 305 or 364, or both) to generate a display, an alert, a recommendation, a notification, or other indication. As indicated by block 620, communication system controller 329 can control communication system 306 to communicate the plug prediction output or the controlled actions of cotton harvester 301, or both, to other systems, such as one or more of user interface mechanisms 364, remote computing systems 368, or other mobile machines 375.

At block 622, the control signals generated by control system 314 are applied to the subsystems.

At block 624, it is determined if the operation is complete. If not, processing returns to block 602 where values are continued to be obtained and plug prediction system 340 continues to predict likely plugging. If the operation has been completed, then the operation ends.

The examples herein describe the generation of a predictive model and, in some examples, the generation of a functional predictive map based on the predictive model. The examples described herein are distinguished from other approaches by the use of a model which is at least one of multi-variate or site-specific (i.e., georeferenced, such as map-based). Furthermore, the model is revised as the work machine is performing an operation and while additional in-situ sensor data is collected. The model may also be applied in the future beyond the current worksite. For example, the model may form a baseline (e.g., starting point) for a subsequent operation at a different worksite or at the same worksite at a future time.

The revision of the model in response to new data may employ machine learning methods. Without limitation, machine learning methods may include memory networks, Bayes systems, decisions trees, Cluster Analysis, Eigenvectors, Eigenvalues and Machine Learning, Evolutionary and Genetic Algorithms, Expert Systems/Rules, Support Vector Machines, Engines/Symbolic Reasoning, Generative Adversarial Networks (GANs), Graph Analytics and ML, Linear Regression, Logistic Regression, LSTMs and Recurrent Neural Networks (RNNSs), Convolutional Neural Networks (CNNs), MCMC, Random Forests, Reinforcement Learning or Reward-based machine learning. Learning may be supervised or unsupervised.

Model implementations may be mathematical, making use of mathematical equations, empirical correlations, statistics, tables, matrices, and the like. Other model implementations may rely more on symbols, knowledge bases, and logic such as rule-based systems. Some implementations are hybrid, utilizing both mathematics and logic. Some models may incorporate random, non-deterministic, or unpredictable elements. Some model implementations may make uses of networks of data values such as neural networks. These are just some examples of models.

The predictive paradigm examples described herein differ from non-predictive approaches where an actuator or other machine parameter is fixed at the time the machine, system, or component is designed, set once before the machine enters the worksite, is reactively adjusted manually based on operator perception, or is reactively adjusted based on a sensor value.

The functional predictive map examples described herein also differ from other map-based approaches. In some examples of these other approaches, an a priori control map is used without any modification based on in-situ sensor data or else a difference determined between data from an in-situ sensor and a predictive map are used to calibrate the in-situ sensor. In some examples of the other approaches, sensor data may be mathematically combined with a priori data to generate control signals, but in a location-agnostic way; that is, an adjustment to an a priori, georeferenced predictive setting is applied independent of the location of the work machine at the worksite. The continued use or end of use of the adjustment, in the other approaches, is not dependent on the work machine being in a particular defined location or region within the worksite.

In examples described herein, the functional predictive maps and predictive actuator control rely on obtained maps and in-situ data that are used to generate predictive models. The predictive models are then revised during the operation to generate revised functional predictive maps and revised actuator control. In some examples, the actuator control is provided based on functional predictive control zone maps which are also revised during the operation at the worksite. In some examples, the revisions (e.g., adjustments, calibrations, etc.) are tied to regions or zones of the worksite rather than to the whole worksite or some non-georeferenced condition. For example, the adjustments are applied to one or more areas of a worksite to which an adjustment is determined to be relevant (e.g., such as by satisfying one or more conditions which may result in application of an adjustment to one or more locations while not applying the adjustment to one or more other locations), as opposed to applying a change in a blanket way to every location in a non-selective way.

In some examples described herein, the models determine and apply those adjustments to selective portions or zones of the worksite based on a set of a priori data, which, in some instances, is multivariate in nature. For example, adjustments may, without limitation, be tied to defined portions of the worksite based on site-specific factors such as topography, soil type, crop variety, soil moisture, as well as various other factors, alone or in combination. Consequently, the adjustments are applied to the portions of the field in which the site-specific factors satisfy one or more criteria and not to other portions of the field where those site-specific factors do not satisfy the one or more criteria. Thus, in some examples described herein, the model generates a revised functional predictive map for at least the current location or zone, the unworked part of the worksite, or the whole worksite.

As an example, in which the adjustment is applied only to certain areas of the field, consider the following. The system may determine that a detected in-situ characteristic value (e.g., detected feedrate value or detected yield value) varies from a predictive value of the characteristic (e.g., predictive feedrate value or predictive yield value), such as by a threshold amount. This deviation may only be detected in areas of the field where the elevation of the worksite is above a certain level. Thus, the revision to the predictive value is only applied to other areas of the worksite having elevation above the certain level. In this simpler example, the predictive characteristic value and elevation at the point the deviation occurred and the detected characteristic value and elevation at the point the deviation cross the threshold are used to generate a linear equation. The linear equation is used to adjust the predictive characteristic value in unharvested areas of the worksite in the functional predictive map as a function of elevation and the predicted characteristic value. This results in a revised functional predictive map in which some values are adjusted while others remain unchanged based on selected criteria, e.g., elevation as well as threshold deviation. The revised functional map is then used to generate a revised functional control zone map for controlling the machine.

As an example, without limitation, consider an instance of the paradigm described herein which is parameterized as follows.

One or more maps of the field are obtained, such as one or more of a vegetative index map, a yield map, a prior product application operation map, a prior irrigation operation map, a soil moisture map, a soil type map, a historical feedrate map, an optical characteristic map, and another type of map.

In-situ sensors generate sensor data indicative of in-situ characteristic values, such as in-situ feedrate values.

A predictive model generator generates one or more predictive models based on the one or more obtained maps and the in-situ sensor data, such as a predictive feedrate model.

A predictive map generator generates one or more functional predictive maps based on a model generated by the predictive model generator and the one or more obtained maps. For example, the predictive map generator may generate a functional predictive feedrate map that maps predictive feedrate values to one or more locations on the worksite based on a predictive feedrate model and the one or more obtained maps.

Control zones, which include machine settings values, can be incorporated into the functional predictive feedrate map to generate a functional predictive feedrate control zone map.

As the mobile machine continues to operate at the worksite, additional in-situ sensor data is collected. A learning trigger criteria can be detected, such as threshold amount of additional in-situ sensor data being collected, a magnitude of change in a relationship (e.g., the in-situ characteristic values varies to a certain [e.g., threshold] degree from a predictive value of the characteristic), and operator or user makes edits to the predictive map(s) or to a control algorithm, or both, a certain (e.g., threshold) amount of time elapses, as well as various other learning trigger criteria. The predictive model(s) are then revised based on the additional in-situ sensor data and the values from the obtained maps. The functional predictive maps or the functional predictive control zone maps, or both, are then revised based on the revised model(s) and the values in the obtained maps.

As another example, without limitation, consider an instance of the paradigm described herein which is parameterized as follows.

One or more maps of the field are obtained, such as one or more of a vegetative index map, a yield map, a prior product application operation map, a prior irrigation operation map, a soil moisture map, a soil type map, a historical feedrate map, an optical characteristic map, and another type of map.

In-situ sensors generate sensor data indicative of in-situ characteristic values, such as in-situ yield values.

A predictive model generator generates one or more predictive models based on the one or more obtained maps and the in-situ sensor data, such as a predictive yield model.

A predictive map generator generates one or more functional predictive maps based on a model generated by the predictive model generator and the one or more obtained maps. For example, the predictive map generator may generate a functional predictive yield map that maps predictive yield values to one or more locations on the worksite based on a predictive yield model and the one or more obtained maps.

Control zones, which include machine settings values, can be incorporated into the functional predictive yield map to generate a functional predictive yield control zone map.

As the mobile machine continues to operate at the worksite, additional in-situ sensor data is collected. A learning trigger criteria can be detected, such as threshold amount of additional in-situ sensor data being collected, a magnitude of change in a relationship (e.g., the in-situ characteristic values varies to a certain [e.g., threshold] degree from a predictive value of the characteristic), and operator or user makes edits to the predictive map(s) or to a control algorithm, or both, a certain (e.g., threshold) amount of time elapses, as well as various other learning trigger criteria. The predictive model(s) are then revised based on the additional in-situ sensor data and the values from the obtained maps. The functional predictive maps or the functional predictive control zone maps, or both, are then revised based on the revised model(s) and the values in the obtained maps.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms may include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition may be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores may be local to the systems accessing the data stores, one or more of the data stores may all be located remote form a system utilizing the data store, or one or more data stores may be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality may be distributed among more components. In different examples, some functionality may be added, and some may be removed.

It will be noted that the above discussion has described a variety of different systems, components, logic and interactions. It will be appreciated that any or all of such systems, components, logic and interactions may be implemented by hardware items, such as processors, memory, or other processing components, some of which are described below, that perform the functions associated with those systems, components, or logic, or interactions. In addition, any or all of the systems, components, logic and interactions may be implemented by software that is loaded into a memory and is subsequently executed by a processor or server or other computing component, as described below. Any or all of the systems, components, logic and interactions may also be implemented by different combinations of hardware, software, firmware, etc., some examples of which are described below. These are some examples of different structures that may be used to implement any or all of the systems, components, logic and interactions described above. Other structures may be used as well.

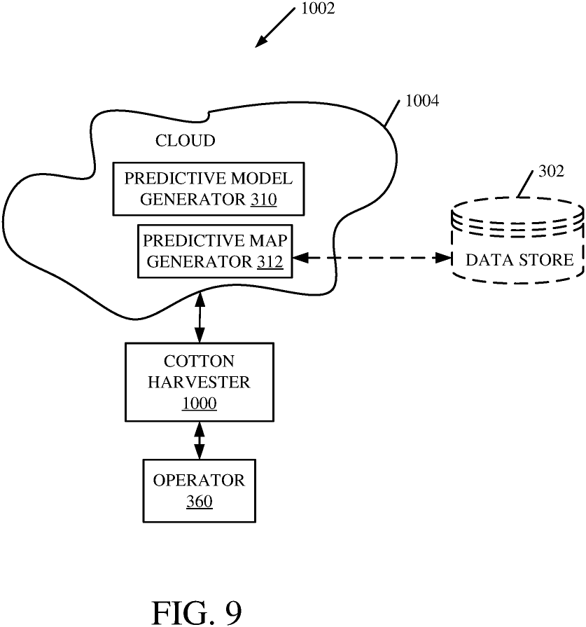

FIG. 9 is a block diagram of cotton harvester 1000, which may be similar to cotton harvester 301 shown in previous FIGS. The cotton harvester 1000 communicates with elements in a remote server architecture 1002. In some examples, remote server architecture 1002 provides computation, software, data access, and storage services that do not require end-user knowledge of the physical location or configuration of the system that delivers the services. In various examples, remote servers may deliver the services over a wide area network, such as the internet, using appropriate protocols. For instance, remote servers may deliver applications over a wide area network and may be accessible through a web browser or any other computing component. Software or components shown in FIG. 4 as well as data associated therewith, may be stored on servers at a remote location. The computing resources in a remote server environment may be consolidated at a remote data center location, or the computing resources may be dispersed to a plurality of remote data centers. Remote server infrastructures may deliver services through shared data centers, even though the services appear as a single point of access for the user. Thus, the components and functions described herein may be provided from a remote server at a remote location using a remote server architecture. Alternatively, the components and functions may be provided from a server, or the components and functions can be installed on client devices directly, or in other ways.

In the example shown in FIG. 9, some items are similar to those shown in FIG. 4 and those items are similarly numbered. FIG. 9 specifically shows that predictive model generator 310 or predictive map generator 312, or both, may be located at a server location 1004 that is remote from the cotton harvester 1000. Therefore, in the example shown in FIG. 9, cotton harvester 1000 accesses systems through remote server location 1004. In other examples, various other items may also be located at server location 1004, such as data store 302, map selector 309, predictive model 311, functional predictive maps 263 (including predictive maps 264 and predictive control zone maps 265), control zone generator 313, control system 314, and processing system 338.

FIG. 9 also depicts another example of a remote server architecture. FIG. 9 shows that some elements of FIG. 4 may be disposed at a remote server location 1004 while others may be located elsewhere. By way of example, data store 302 may be disposed at a location separate from location 1004 and accessed via the remote server at location 1004. Regardless of where the elements are located, the elements can be accessed directly by cotton harvester 1000 through a network such as a wide area network or a local area network; the elements can be hosted at a remote site by a service; or the elements can be provided as a service or accessed by a connection service that resides in a remote location. Also, data may be stored in any location, and the stored data may be accessed by, or forwarded to, operators, users or systems. For instance, physical carriers may be used instead of, or in addition to, electromagnetic wave carriers. In some examples, where wireless telecommunication service coverage is poor or nonexistent, another machine, such as a fuel truck or other mobile machine or vehicle, may have an automated, semi-automated or manual information collection system. As the cotton harvester 1000 comes close to the machine containing the information collection system, such as a fuel truck prior to fueling, the information collection system collects the information from the cotton harvester 1000 using any type of ad-hoc wireless connection. The collected information may then be forwarded to another network when the machine containing the received information reaches a location where wireless telecommunication service coverage or other wireless coverage- is available. For instance, a fuel truck may enter an area having wireless communication coverage when traveling to a location to fuel other machines or when at a main fuel storage location. All of these architectures are contemplated herein. Further, the information may be stored on the cotton harvester 1000 until the cotton harvester 1000 enters an area having wireless communication coverage. The cotton harvester 1000, itself, may send the information to another network.

It will also be noted that the elements of FIG. 4, or portions thereof, may be disposed on a wide variety of different devices. One or more of those devices may include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 1002 may include cybersecurity measures. Without limitation, these measures may include encryption of data on storage devices, encryption of data sent between network nodes, authentication of people or processes accessing data, as well as the use of ledgers for recording metadata, data, data transfers, data accesses, and data transformations. In some examples, the ledgers may be distributed and immutable (e.g., implemented as blockchain).

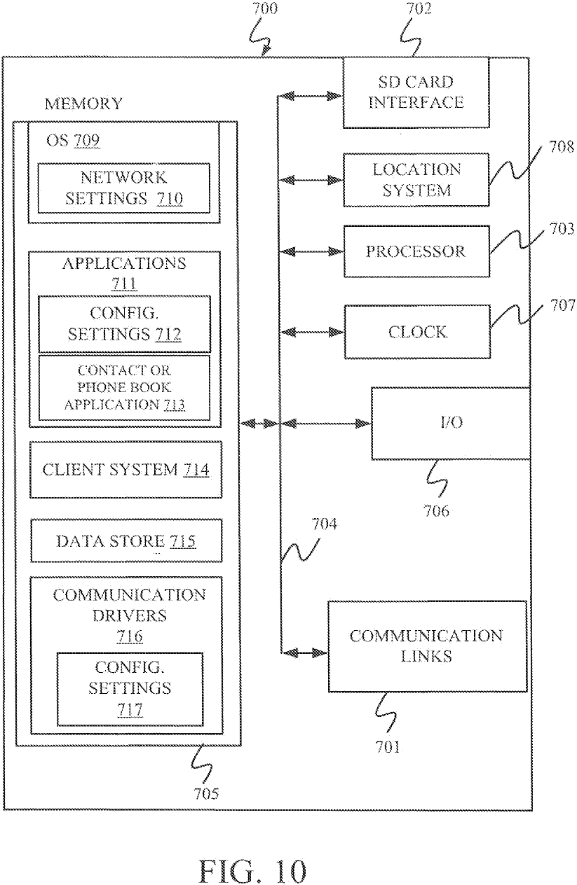

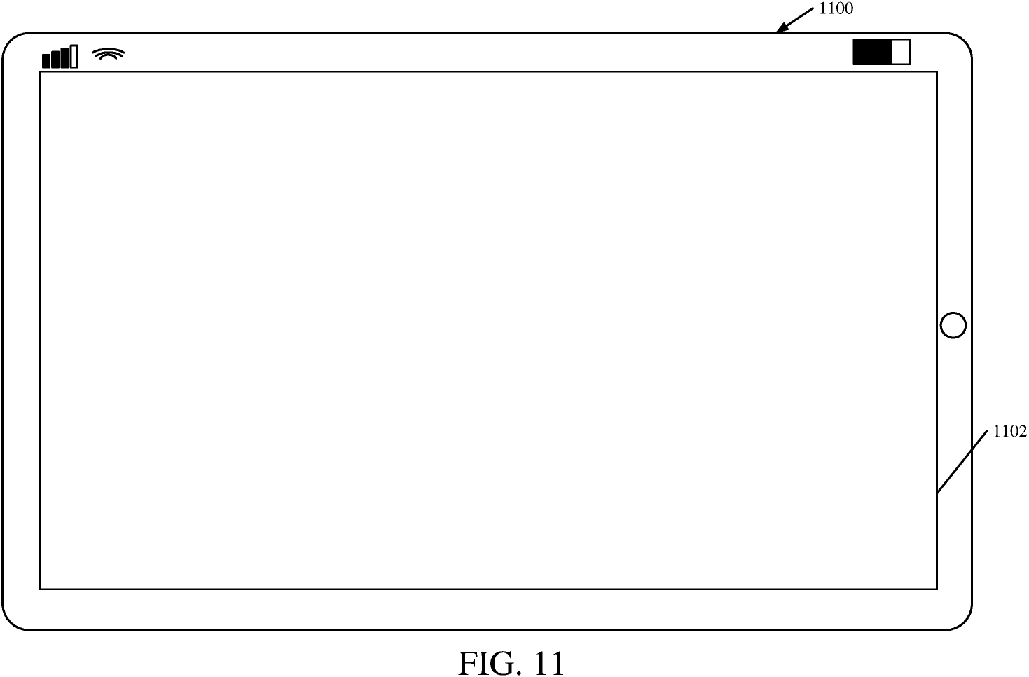

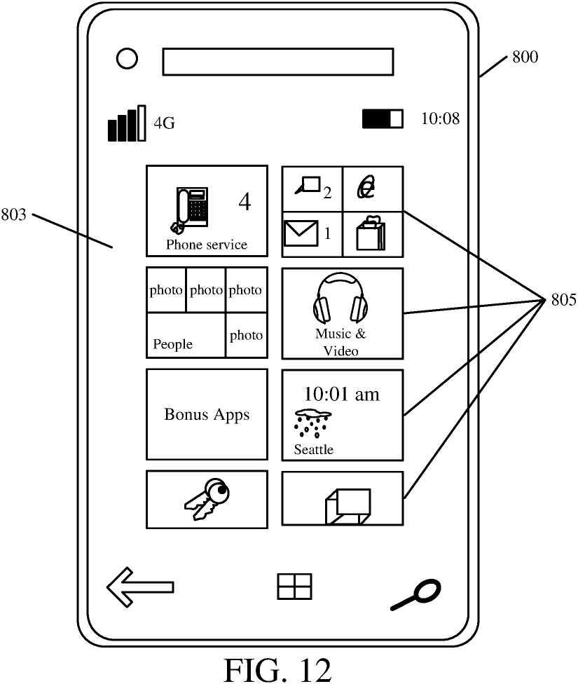

FIG. 10 is a simplified block diagram of one illustrative example of a handheld or mobile computing device that can be used as a user’s or client’s hand held device 700, in which the present system (or parts of it) can be deployed. For instance, a mobile device can be deployed in the operator compartment of cotton harvester 301 for use in generating, processing, or displaying the maps discussed above. FIGS. 11-12 are examples of handheld or mobile devices.

FIG. 10 provides a general block diagram of the components of a client device 700 that can run some components shown in FIG. 4, that interacts with them, or both. In the device 700, a communications link 701 is provided that allows the handheld device to communicate with other computing devices and under some examples provides a channel for receiving information automatically, such as by scanning. Examples of communications link 701 include allowing communication though one or more communication protocols, such as wireless services used to provide cellular access to a network, as well as protocols that provide local wireless connections to networks.

In other examples, applications can be received on a removable Secure Digital (SD) card that is connected to an interface 702. Interface 702 and communication links 701 communicate with a processor 703 (which can also embody processors or servers from other FIGS.) along a bus 704 that is also connected to memory 705 and input/output (I/O) components 706, as well as clock 707 and location system 708.

I/O components 706, in one example, are provided to facilitate input and output operations. I/O components 706 for various examples of the device 700 can include input components such as buttons, touch sensors, optical sensors, microphones, touch screens, proximity sensors, accelerometers, orientation sensors and output components such as a display device, a speaker, and or a printer port. Other I/O components 706 can be used as well.

Clock 707 illustratively comprises a real time clock component that outputs a time and date. It can also, illustratively, provide timing functions for processor 703.

Location system 708 illustratively includes a component that outputs a current geographical location of device 700. This can include, for instance, a global positioning system (GPS) receiver, a LORAN system, a dead reckoning system, a cellular triangulation system, or other positioning system. Location system 708 can also include, for example, mapping software or navigation software that generates desired maps, navigation routes and other geographic functions.

Memory 705 stores operating system 709, network settings 710, applications 711, application configuration settings 712, contact or phone book applications 713, client system 714, data store 715, communication drivers 716, and communication configuration settings 717. Memory 705 can include all types of tangible volatile and non-volatile computer-readable memory devices. Memory 705 may also include computer storage media (described below). Memory 705 stores computer readable instructions that, when executed by processor 703, cause the processor to perform computer-implemented steps or functions according to the instructions. Processor 703 may be activated by other components to facilitate their functionality as well.

FIG. 11 shows one example in which device 700 is a tablet computer 1100. In FIG. 11, computer 1100 is shown with user interface display screen 1102. Screen 1102 can be a touch screen or a pen-enabled interface that receives inputs from a pen or stylus. Tablet computer 1100 may also use an on-screen virtual keyboard. Of course, computer 1100 might also be attached to a keyboard or other user input device through a suitable attachment mechanism, such as a wireless link or USB port, for instance. Computer 1100 may also illustratively receive voice inputs as well.

FIG. 12 is similar to FIG. 11 except that the device is a smart phone 800. Smart phone 800 has a touch sensitive display 803 that displays icons or tiles or other user input mechanisms 805. Mechanisms 805 can be used by a user to run applications, make calls, perform data transfer operations, etc. In general, smart phone 800 is built on a mobile operating system and offers more advanced computing capability and connectivity than a feature phone.

Note that other forms of the devices 700 are possible.

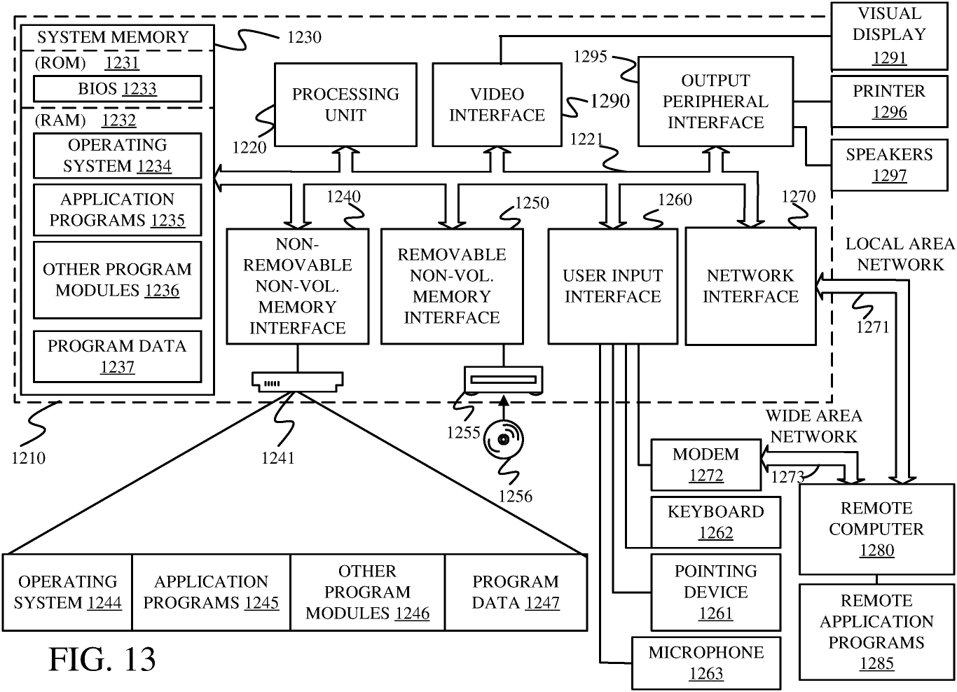

FIG. 13 is one example of a computing environment in which elements of FIG. 4 can be deployed. With reference to FIG. 13, an example system for implementing some embodiments includes a computing device in the form of a computer 1210 programmed to operate as discussed above. Components of computer 1210 may include, but are not limited to, a processing unit 1220 (which can comprise processors or servers from previous FIGS.), a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. Memory and programs described with respect to FIG. 4 can be deployed in corresponding portions of FIG. 13.

Computer 1210 typically includes a variety of computer readable media. Computer readable media may be any available media that can be accessed by computer 1210 and includes both volatile and nonvolatile media, removable and non-removable media. By way of example, and not limitation, computer readable media may comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220. By way of example, and not limitation, FIG. 13 illustrates operating system 1234, application programs 1235, other program modules 1236, and program data 1237.

The computer 1210 may also include other removable/non-removable volatile/nonvolatile computer storage media. By way of example only, FIG. 13 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 1210. In FIG. 13, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user may enter commands and information into the computer 1210 through input devices such as a keyboard 1262, a microphone 1263, and a pointing device 1261, such as a mouse, trackball or touch pad. Other input devices (not shown) may include a joystick, game pad, satellite dish, scanner, or the like. These and other input devices are often connected to the processing unit 1220 through a user input interface 1260 that is coupled to the system bus, but may be connected by other interface and bus structures. A visual display 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1295.

The computer 1210 is operated in a networked environment using logical connections (such as a controller area network - CAN, local area network - LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules may be stored in a remote memory storage device. FIG. 13 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

The foregoing description and examples has been set forth merely to illustrate the disclosure and are not intended as being limiting. Each of the disclosed aspects and embodiments of the present disclosure may be considered individually or in combination with other aspects, embodiments, and variations of the disclosure. In addition, unless otherwise specified, none of the steps of the methods of the present disclosure are confined to any particular order of performance. Modifications of the disclosed embodiments incorporating the spirit and substance of the disclosure may occur to persons skilled in the art and such modifications are within the scope of the present disclosure. Furthermore, all references cited herein are incorporated by reference in their entirety.

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

Although systems and methods for generating functional predictive maps and controlling a machine based on functional predictive maps have been disclosed in the context of certain embodiments and examples, this disclosure extends beyond the specifically disclosed embodiments to other alternative embodiments and/or uses of the embodiments and certain modifications and equivalents thereof. Various features and aspects of the disclosed embodiments can be combined with or substituted for one another in order to form varying modes of systems and methods for generating functional predictive maps and controlling a machine based on functional predictive maps. The scope of this disclosure should not be limited by the particular disclosed embodiments described herein.

Certain features that are described in this disclosure in the context of separate implementations can be implemented in combination in a single implementation. Conversely, various features that are described in the context of a single implementation can be implemented in multiple implementations separately or in any suitable subcombination. Although features may be described herein as acting in certain combinations, one or more features from a claimed combination can, in some cases, be excised from the combination, and the combination may be claimed as any subcombination or variation of any subcombination.

While the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various embodiments described and the appended claims. Further, the disclosure herein of any particular feature, aspect, method, property, characteristic, quality, attribute, element, or the like in connection with an embodiment can be used in all other embodiments set forth herein. Any methods disclosed herein need not be performed in the order recited. Depending on the embodiment, one or more acts, events, or functions of any of the algorithms, methods, or processes described herein can be performed in a different sequence, can be added, merged, or left out altogether (e.g., not all described acts or events are necessary for the practice of the algorithm). In some embodiments, acts or events can be performed concurrently, e.g., through multi-threaded processing, interrupt processing, or multiple processors or processor cores or on other parallel architectures, rather than sequentially. Further, no element, feature, block, or step, or group of elements, features, blocks, or steps, are necessary or indispensable to each embodiment. Additionally, all possible combinations, subcombinations, and rearrangements of systems, methods, features, elements, modules, blocks, and so forth are within the scope of this disclosure. The use of sequential, or time-ordered language, such as “then,” “next,” “after,” “subsequently,” and the like, unless specifically stated otherwise, or otherwise understood within the context as used, is generally intended to facilitate the flow of the text and is not intended to limit the sequence of operations performed. Thus, some embodiments may be performed using the sequence of operations described herein, while other embodiments may be performed following a different sequence of operations.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described herein should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying figures. Certain figures are drawn and/or shown to scale, but such scale should not be limiting, since dimensions and proportions other than what are shown are contemplated and are within the scope of the embodiments disclosed herein. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

The methods disclosed herein may include certain actions taken by a practitioner; however, the methods can also include any third-party instruction of those actions, either expressly or by implication. For example, actions such as “positioning an electrode” include “instructing positioning of an electrode.”

The ranges disclosed herein also encompass any and all overlap, subranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 1 V” includes “1 V.” Phrases preceded by a term such as “substantially” include the recited phrase and should be interpreted based on the circumstances (e.g., as much as reasonably possible under the circumstances). For example, “substantially perpendicular” includes “perpendicular.” Unless stated otherwise, all measurements are at standard conditions including temperature and pressure.

In summary, various embodiments and examples of systems and methods for generating functional predictive maps and controlling a machine based on functional predictive maps, have been disclosed. Although the systems and methods for generating functional predictive maps and controlling a machine based on functional predictive maps have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described herein, but should be determined only by a fair reading of the claims that follow.

What is claimed is:

1. A cotton harvesting system comprising:
a communication system configured to receive an information map that includes values of a characteristic corresponding to different geographic locations in a worksite at which a cotton harvester performs an operation;
an in-situ sensor configured to detect a value of feedrate corresponding to a geographic location in the worksite;
one or more processors; and
a data store configured to store computer executable instructions that, when executed by the one or more processors, are configured to configure the one or more processors to:
generate a predictive model that models a relationship between values of the characteristic and values of feedrate based on a value of the characteristic in the information map at the geographic location and the value of feedrate detected by the in-situ sensor corresponding to the geographic location; and
generate a functional predictive map of the worksite, that maps predictive values of feedrate to the different geographic locations in the worksite, based on the values of the characteristic in the information map and based on the predictive model.

2. The cotton harvesting system of claim 1, wherein the computer executable instructions, when executed by the one or more processors, are further configured to configure the one or more processors to:
generate a control signal to control a controllable subsystem of the cotton harvester based on the functional predictive map.

3. The cotton harvesting system of claim 1, wherein the information map comprises a vegetative index map that maps, as the values of the characteristic, vegetative index values to the different geographic locations in the worksite, and wherein the predictive model models a relationship between vegetative index values and values of feedrate based on the value of feedrate detected by the in-situ sensor corresponding to the geographic location and the vegetative index value, in the vegetative index map, at the geographic location, the predictive model being configured to receive a vegetative index value as a model input and generate a value of feedrate as a model output based on the identified relationship.

4. The cotton harvesting system of claim 1, wherein the information map comprises a yield map that maps, as the values of the characteristic, yield values to the different geographic locations in the worksite, and wherein the predictive model models a relationship between yield values and values of feedrate based on the value of feedrate detected by the in-situ sensor corresponding to the geographic location and the yield value, in the yield map, at the geographic location, the predictive model being configured to receive a yield value as a model input and generate a value of feedrate as a model output based on the identified relationship.

5. The cotton harvesting system of claim 1, wherein the information map comprises a prior product application operation map that maps, as the values of the characteristic, prior product application operation characteristic values to the different geographic locations in the worksite, and wherein the predictive model models a relationship between prior product application operation characteristic values and values of feedrate based on the value of feedrate detected by the in-situ sensor corresponding to the geographic location and the prior product application operation characteristic value, in the prior product application operation map, at the geographic location, the predictive model being configured to receive a prior product application operation characteristic value as a model input and generate a value of feedrate as a model output based on the identified relationship.

6. The cotton harvesting system of claim 1, wherein the information map comprises a prior irrigation operation map that maps, as the values of the characteristic, prior irrigation operation characteristic values to the different geographic locations in the worksite, and wherein the predictive model models a relationship between prior irrigation operation characteristic values and values of feedrate based on the value of feedrate detected by the in-situ sensor corresponding to the geographic location and the prior irrigation operation characteristic value, in the prior irrigation operation map, at the geographic location, the predictive model being configured to receive a prior irrigation operation characteristic value as a model input and generate a value of feedrate as a model output based on the identified relationship.

7. The cotton harvesting system of claim 1, wherein the information map comprises a soil moisture map that maps, as the values of the characteristic, soil moisture values to the different geographic locations in the worksite, and wherein the predictive model models a relationship between soil moisture values and values of feedrate based on the value of feedrate detected by the in-situ sensor corresponding to the geographic location and the soil moisture value, in the soil moisture map, at the geographic location, the predictive model being configured to receive a soil moisture value as a model input and generate a value of feedrate as a model output based on the identified relationship.

8. The cotton harvesting system of claim 1, wherein the information map comprises a soil type map that maps, as the values of the characteristic, soil type values to the different geographic locations in the worksite, and wherein the predictive model models a relationship between soil type values and values of feedrate based on the value of feedrate detected by the in-situ sensor corresponding to the geographic location and the soil type value, in the soil type map, at the geographic location, the predictive model being configured to receive a soil type value as a model input and generate a value of feedrate as a model output based on the identified relationship.

9. The cotton harvesting system of claim 1, wherein the information map comprises a historical feedrate map that maps, as the values of the characteristic, historical feedrate values to the different geographic locations in the worksite, and wherein the predictive model models a relationship between historical feedrate values and values of feedrate based on the value of feedrate detected by the in-situ sensor corresponding to the geographic location and the historical feedrate value, in the historical feedrate map, at the geographic location, the predictive model being configured to receive a historical feedrate value as a model input and generate a value of feedrate as a model output based on the identified relationship.

10. The cotton harvesting system of claim 1, wherein the information map comprises an optical characteristic map that maps, as the values of the characteristic, optical characteristic values to the different geographic locations in the worksite, and wherein the predictive model models a relationship between optical characteristic values and values of feedrate based on the value of feedrate detected by the in-situ sensor corresponding to the geographic location and the optical characteristic value, in the optical characteristic map, at the geographic location, the predictive model being configured to receive an optical characteristic value as a model input and generate a value of feedrate as a model output based on the identified relationship.

11. The agricultural system of claim 1, wherein the computer executable instructions, when executed by the one or more processors, are further configured to configure the one or more processors to:
predict likely plugging of the cotton harvester based on the functional predictive map.

12. The agricultural system of claim 11, wherein the computer executable instructions, when executed by the one or more processors, are further configured to configure the one or more processors to:
obtain a predictive value of feedrate for a given location from the functional predictive map;
compare the predictive value of feedrate for the given location to a threshold feedrate value; and
determine likely plugging of the cotton harvester at the given location based on the comparison and generate a plug prediction output indicative of the likely plugging at the given location.

13. A computer implemented method of generating a functional predictive map, comprising:
obtaining an information map that indicates values of a characteristic corresponding to different geographic locations in a worksite;
detecting, with an-situ sensor, a value of feedrate corresponding a geographic location while a cotton harvester is operating at the worksite;
generating a predictive model that models a relationship between values of the characteristic and values of feedrate; and
controlling a predictive map generator to generate the functional predictive map of the worksite, that maps predictive values of feedrate to the different locations in the worksite based on the values of the characteristic in the information map and the predictive model.

14. The computer implemented method of claim 13, and further comprising:
generating a control signal to control a controllable subsystem of the cotton harvester based on the functional predictive map.

15. The computer implemented method of claim 13 and further comprising:
detecting likely plugging of the cotton harvester at a given location based on the functional predictive map.

16. The computer implemented method of claim 15, wherein detecting likely plugging of the cotton harvester at a given location based on the functional predictive map comprises:
comparing the predictive value of feedrate for the given location to a threshold feedrate value and determining that plugging is likely to occur at the given location based on the comparison.

17. The computer implemented method of claim 16 and further comprising:
generating a control signal to control a propulsion subsystem of the cotton harvester to adjust a travel speed of the cotton harvester based on the determined likely plugging at the given location.

18. The computer implemented method of claim 13, wherein receiving the information map comprises receiving two or more maps that each map values of a respective characteristic, the two or more maps comprising two or more of a vegetative index map that maps, as the values of the respective characteristic, vegetative index values to the different geographic locations in the worksite, a yield map that maps, as the values of the respective characteristic, yield values to the different geographic locations in the worksite, a prior product application operation map that maps, as the values of the respective characteristic, prior product application operation characteristic values to the different geographic locations in the worksite, a prior irrigation operation map that maps, as the respective characteristic, a prior irrigation operation characteristic values to the different geographic locations in the worksite, a soil moisture map that maps, as the respective characteristic, soil moisture values to the different geographic locations in the worksite, a soil type map that maps, as the respective characteristic, soil type values to the different geographic locations in the worksite, a historical feedrate map that maps, as the respective characteristic, historical feedrate values to the different geographic locations in the worksite, and an optical characteristic map that maps, as the respective characteristic, optical characteristic values to the different geographic locations in the worksite and wherein generating the predictive model comprises two or more of:
identifying a relationship between vegetative index values and values of feedrate based on the value of feedrate detected by the in-situ sensor corresponding to the geographic location and the vegetative index value, in the vegetative index map, at the geographic location;
identifying a relationship between yield values and values of feedrate based on the value of feedrate detected by the in-situ sensor corresponding to the geographic location and the yield value, in the yield map, at the geographic location;
identifying a relationship between prior product application operation characteristic values and values of feedrate based on the value of feedrate detected by the in-situ sensor corresponding to the geographic location and the prior product application operation characteristic value, in the prior product application operation map, at the geographic location;
identifying a relationship between prior irrigation operation characteristic values and values of feedrate based on the value of feedrate detected by the in-situ sensor corresponding to the geographic location and the prior irrigation operation characteristic value, in the prior irrigation operation map, at the geographic location;
identifying a relationship between soil moisture values and values of feedrate based on the value of feedrate detected by the in-situ sensor corresponding to the geographic location and the soil moisture value, in the soil moisture map, at the geographic location;
identifying a relationship between soil type values and values of feedrate based on the value of feedrate detected by the in-situ sensor corresponding to the geographic location and the soil type value, in the soil type map, at the geographic location;
identifying a relationship between historical feedrate values and values of feedrate based on the value of feedrate detected by the in-situ sensor corresponding to the geographic location and the historical feedrate value, in the historical feedrate map, at the geographic location; and
identifying a relationship between optical characteristic values and values of feedrate based on the value of feedrate detected by the in-situ sensor corresponding to the geographic location and the optical characteristic value, in the optical characteristic map, at the geographic location; and
wherein controlling the predictive map generator to generate the functional predictive map of the worksite, comprises controlling the predictive map generate to generate the functional predictive map of the worksite based on two or more of the vegetative index values in the vegetative index map, the yield values in the yield map, the prior product application operation characteristic values in the prior product application operation map, the prior irrigation operation characteristic values in the prior irrigation operation map, the soil moisture values in the soil moisture map, the soil type values in the soil type map, the historical feedrate values in the historical feedrate map, and the optical characteristic values in the optical characteristic map and based on the predictive model.

19. A cotton harvesting system comprising:
a communication system configured to receive an information map that includes values of a characteristic corresponding to different geographic locations in a worksite at which a cotton harvester performs an operation;
an in-situ sensor configured to detect a value of yield corresponding to a geographic location in the worksite;
one or more processors; and
a data store configured to store computer executable instructions that, when executed by the one or more processors, are configured to configure the one or more processors to:
generate a predictive model that models a relationship between values of the characteristic and values of yield based on a value of the characteristic in the information map at the geographic location and the value of yield detected by the in-situ sensor corresponding to the geographic location; and
generate a functional predictive map of the worksite, that maps predictive values of yield to the different geographic locations in the worksite, based on the values of the characteristic in the information map and based on the predictive model.

20. The cotton harvesting system of claim 19, wherein the computer executable instructions, when executed by the one or more processors, are further configured to configure the one or more processors to:
generate a control signal to control a controllable subsystem of the cotton harvester based on the functional predictive map.
